(19) United States
(12) Patent Application Publication
(10) Pub. No.: US 2022/0264803 A1
(43) Pub. Date: Aug. 25, 2022

(54) Threshing Device

(71) Applicant: Kubota Corporation, Osaka-shi (JP)

(72) Inventors: Takafumi Mitsui, Sakai-shi (JP); Shuya Ueda, Sakai-shi (JP); Hiroki Hashimoto, Sakai-shi (JP); Yoshiaki Inoue, Sakai-shi (JP); Tsuyoshi Kumatori, Sakai-shi (JP); Toshinari Nishimura, Sakai-shi (JP)

(21) Appl. No.: 17/631,384

(22) PCT Filed: Jul. 29, 2020
(86) PCT No.: PCT/JP2020/029037

§ 371 Date: Jan. 28, 2022

(30) Foreign Application Priority Data
Jul. 31, 2019 (JP) 2019-140465
Jul. 31, 2019 (JP) 2019-140466
Jul. 31, 2019 (JP) 2019-140467
Jul. 31, 2019 (JP) 2019-140468
Jul. 31, 2019 (JP) 2019-140470

(51) Int. Cl. A01F 12/44; A01F 12/10; A01F 7/06; A01F 12/56; A01F 12/34

(52) U.S. Cl. CPC A01F 12/444; A01F 12/10; A01F 7/06; A01F 12/446; A01F 12/56; A01F 12/34

(57) ABSTRACT

A threshing apparatus includes: a threshing unit 5; a first sorting unit 11 that is arranged below the threshing unit 5, is driven to reciprocate along the front-rear direction, and threshes processed material from the threshing unit 5; and a second sorting unit 12 that is arranged below the first sorting unit 11, is driven to reciprocate along the front-rear direction, and threshes processed material from the first sorting unit 11. The front end portion of the second sorting unit 12 is provided with a second grain pan 22 that conveys processed material rearward, and the front end portion of the second grain pan 22 is also provided with a wall portion 48 that is higher than the second grain pan 22 in order to be able to prevent processed material from falling forward from the second grain pan 22.

### CROSS-REFERENCE TO RELATED APPLICATIONS

This application is the United States national phase of International Application No. PCT/JP2020/029037 filed Jul. 29, 2020, and claims priority to Japanese Patent Application Nos. 2019-140465, 2019-140466, 2019-140467, 2019-140468, and 2019-140470, filed Jul. 31, 2019, the disclosures of which are hereby incorporated by reference in their entirety.

### BACKGROUND OF THE INVENTION

### Field of the Invention

The present invention relates to a configuration of a sorting unit in a threshing apparatus.

### Description of Related Art

Threshing apparatuses disclosed in JP 2016-36261A (Patent Document 1), JP 2014-161262A (Patent Document 2), and JP 2014-161263A (Patent Document 3) include a threshing unit, a sorting unit arranged below the threshing unit, and a grain fan that supplies sorting wind to the sorting unit. A harvested crop is threshed by the threshing unit, and the processed material from the threshing unit is subjected to sorting performed by the sorting unit that is supplied with sorting wind from the grain fan.

A threshing apparatus disclosed in JP 2019-4837A (Patent Document 4) includes a threshing unit and a sorting unit that is arranged below the threshing unit, a harvested crop is threshed by the threshing unit, and the processed material obtained by the threshing unit is sorted by the sorting unit.

A chaff sieve is provided in the sorting unit, and the chaff sieve has a configuration in which a large number of chaff lips that extend along the left-right direction are arranged side by side along the front-rear direction. In the chaff sieve, the spacing between adjacent chaff lips can be changed according to the type of crop, the condition of the crop, and the like.

In JP 2019-4837A, a gap changing portion can operate the chaff lips toward an open state or a closed state so as to increase or decrease the size of the gaps between the chaff lips, a tension spring is connected to the gap changing portion, and the gap changing portion is biased toward the closed state by compression of the tension spring.

A wire is connected to and extends between the actuator and the gap changing portion, and when the wire is pulled toward an actuator by the actuator, the tension spring extends and the gap changing portion is operated toward the open state. When the wire is returned toward the gap changing portion by the actuator, the tension spring contracts and the gap changing portion is operated toward the closed state.
Patent Document 1: JP 2016-36261A
Patent Document 2: JP 2014-161262A
Patent Document 3: JP 2014-161263A
Patent Document 4: JP 2019-4837A

### SUMMARY OF THE INVENTION

The following is a first problem corresponding to Patent Documents 1-3. In threshing apparatuses of recent years, improvements in threshing performance in threshing units have made it possible to thresh large amounts of crop.

An object of the present invention is to provide a threshing apparatus that can thresh a large amount of crop while also being able to appropriately perform sorting processing on processed material from the threshing unit.

The following is a second problem corresponding to Patent Documents 1-3. In the sorting unit located below the threshing unit, it was found that when sorting wind from the grain fan is supplied to the sorting unit through the space between the right and left side walls, a larger amount of the sorting wind from the grain fan flows along the side walls, and a smaller amount of the sorting wind from the grain fan flows in the lateral central region between the right and left side walls. Accordingly, more sorting wind from the grain fan is supplied to the regions near the side walls in the sorting unit, and less sorting wind from the grain fan is supplied to the lateral central region in the sorting unit, and it is possible that the sorting in the sorting unit is not uniform in the left-right direction.

An object of the present invention is to provide a threshing apparatus in which sorting processing in the sorting unit is performed uniformly in the left-right direction.

The following is a problem corresponding to Patent Document 4. In the case where a tension spring is connected to the gap changing portion as in JP 2019-4837A, the two end portions of the tension spring are bent to form hook portions, one hook portion of the tension spring is hung on a pin on a side plate or the like of the sorting unit, and the other hook portion of the tension spring is hung on a pin of the gap changing portion.

In this configuration, when the gaps between the chaff lips of the chaff sieve are repeatedly changed and the tension spring repeatedly extends and contracts, stress becomes concentrated on the hook portions of the tension spring, and this can possibly lead to breakage of the hook portions of the tension spring.

An object of the present invention is to provide a threshing apparatus in which it is possible to prevent damage to a spring in the case where the gaps between the chaff lips of a chaff sieve are changed by an actuator, a wire, and the spring.

First Invention

A threshing apparatus according to a first embodiment includes: a threshing unit configured to thresh a harvested crop; a first sorting unit that is arranged below the threshing unit, is reciprocally drivable along a front-rear direction, and is configured to perform sorting on a processed material from the threshing unit; and a second sorting unit that is arranged below the first sorting unit, is reciprocally drivable along the front-rear direction, and is configured to perform sorting on a processed material from the first sorting unit, wherein the second sorting unit includes a front end portion that is provided with a second grain pan configured to convey processed material rearward, and the second grain pan includes a front end portion that is provided with a wall portion that is higher than the second grain pan so as to prevent processed material from falling forward from the second grain pan.

According to the present invention, a harvested crop is threshed in the threshing unit, and the processed material falls to the first sorting unit therebelow and is subjected to sorting. In the first sorting unit, the processed material is sorted into grain that is to be collected and straw waste or the like that is to be discharged, and the grain and some of the straw waste or the like falls to the second sorting unit therebelow, and much of the straw waste or the like is discharged. In the second sorting unit, the processed material is sorted into grain that is to be collected and straw waste or the like that is to be discharged, and the grain is collected and the straw waste or the like is discharged.

According to the present invention, the processed material from the threshing unit is sorted in two stages by the first sorting unit and the second sorting unit, and therefore compared with a configuration in which processed material from the threshing unit is sorted by one large sorting unit that has a large area in a plan view, more processed material from the threshing unit can be efficiently sorted, and the sorting capability of the threshing apparatus is improved.

According to the present invention, the second grain pan is provided at the front end portion of the second sorting unit, and the wall portion that is higher than the second grain pan is provided at the front end portion of the second grain pan. Accordingly, even if processed material is about to fall forward from the second grain pan due to the reciprocating of the second sorting unit, the falling of the processed material is prevented by the wall portion, and therefore it is possible to reduce the amount of processed material that is not sorted, and the performance of processed material sorting processing is improved in the second sorting unit.

In the first invention described above, it is preferable that an upper portion of the wall portion is inclined upward and rearward, the threshing apparatus further includes a grain fan configured to supply sorting wind to the first sorting unit and the second sorting unit, and a portion of the sorting wind from the grain fan flows rearward between the first sorting unit and the wall portion.

A threshing apparatus is often provided with a grain fan that supplies sorting wind, and in the present invention, a portion of the sorting wind from the grain fan flows rearward in the space between the first sorting unit and the wall portion at the front end portion of the second grain pan.

According to the present invention, the upper portion of the wall portion is inclined diagonally upward and rearward, and therefore a portion of the sorting wind from the grain fan smoothly flows rearward without being obstructed in the space between the first sorting unit and the wall portion at the front end portion of the second grain pan. If the upper portion of the wall portion is inclined diagonally upward and rearward, the upper portion of the wall portion covers the front end portion of the second grain pan from above, and therefore the wall portion effectively prevents the processed material from falling out from the second sorting unit.

In the first invention described above, it is preferable that the threshing apparatus further includes: a primary material collecting unit provided below the second sorting unit; a secondary material collecting unit provided at a position that is below the second sorting unit and rearward of the primary material collecting unit; a grain fan that is configured to supply sorting wind to the first sorting unit and the second sorting unit, and is located forward of the primary material collecting unit; a first grain pan configured to convey processed material rearward, a first chaff sieve configured to perform sorting while conveying processed material rearward and allow processed material to fall downward, and a straw rack configured to perform sorting while conveying processed material rearward and allow processed material to fall downward, the first grain pan, the first chaff sieve, and the straw rack extending in stated order between a front portion and a rear portion of the first sorting unit; and a second grain pan, a grain sieve configured to allow sorted processed material to fall to the primary material collecting unit, and a second chaff sieve configured to perform sorting while conveying the processed material rearward and allow processed material to fall to the secondary material collecting unit, the second grain pan, the grain sieve, and the second chaff sieve extending in stated order between a front portion and a rear portion of the second sorting unit.

According to the present invention, the first sorting unit is provided with the first grain pan, the first chaff sieve, and the straw rack, and processed material from the threshing unit is appropriately sorted in the first sorting unit. The second sorting unit is provided with the second grain pan, the grain sieve, and the second chaff sieve, processed material from the first sorting unit is appropriately sorted in the second sorting unit, grain obtained as sorted processed material is collected in the primary material collecting unit, and a mixture of grain and straw waste or the like obtained as sorted processed material is collected in the secondary material collecting unit.

In the first invention described above, it is preferable that the threshing apparatus further includes: a front partition unit that is mountain-shaped and projects upward in a side view, and is located between the primary material collecting unit and the grain fan, wherein the grain sieve extends rearward from a rear end portion of the second grain pan, and when the second sorting unit is located at a front end in reciprocating driving, the rear end portion of the second grain pan is located rearward of a vertical line that passes through a peak portion of the front partition unit in a side view.

According to the present invention, in the second sorting unit, grain obtained as sorted processed material falls from the grain sieve to the primary material collecting unit, and a front partition unit is provided between the primary material collecting unit and the grain fan.

In the case where the second sorting unit is driven to reciprocate along the front-rear direction, according to the present invention, when the second sorting unit is located at the front end in reciprocating driving, the rear end portion of the second grain pan is located rearward of a vertical line that passes through a peak portion of the front partition unit in a side view, and the rear end portion of the second grain pan does not move forward beyond the vertical line that passes through the peak portion of the front partition unit in a side view. As a result, grain that has fallen from the vicinity of the front end portion of the grain sieve is less likely to fall forward of the peak portion of the front partition unit and be collected by the primary material collecting unit, thus resulting in higher grain recovery efficiency.

In the first invention described above, it is preferable that the first chaff sieve extends rearward from a rear end portion of the first grain pan, and the first grain pan, the first chaff sieve, and the second grain pan are arranged such that a rear portion of the first grain pan and a front portion of the first chaff sieve are overlapped with the second grain pan in a plan view.

In the first sorting unit, processed material that has fallen from the threshing unit to the first grain pan is conveyed rearward along the first grain pan, and is then conveyed to the first chaff sieve, and the sorted processed material obtained by the first chaff sieve falls downward.

According to the present invention, in the first sorting unit and the second sorting unit, the rear portion of the first grain pan, the front portion of the first chaff sieve, and the second grain pan are overlapped with each other in a plan view.

Accordingly, processed material that has fallen from the rear end portion of the first grain pan (the front end portion of the first chaff sieve) does not fall forward of the second grain pan, but instead efficiently falls to the second grain pan, and is conveyed from second grain pan to grain sieve, and thus the efficiency of grain recovery is improved.

In the first invention described above, it is preferable that the rear end portion of the first grain pan is located above a front-rear center portion of the second grain pan.

According to the present invention, processed material that has fallen from the rear end portion of the first grain pan (the front end portion of the first chaff sieve) falls to a position near the front-rear center portion of the second grain pan and is conveyed from the second grain pan to the grain sieve, and the efficiency of grain recovery is improved.

In the first invention described above, it is preferable that the threshing apparatus further includes: a conveying screw that is provided in the secondary material collecting unit and configured to convey processed material by being driven to rotate about a screw axis that extends along a left-right direction; and a rear partition unit that is mountain-shaped and projects upward in a side view, and is located between the primary material collecting unit and the secondary material collecting unit, wherein a rear end portion of the grain sieve is located between a vertical line that passes through a peak portion of the rear partition unit and a vertical line that passes through the screw axis in a side view.

In the second sorting unit, grain falls from the grain sieve and is collected in the primary material collecting unit, and processed material that reaches the rear end portion of the grain sieve without falling from the grain sieve is a mixture of grain and straw waste or the like, and such processed material falls from the rear end portion of the grain sieve to the secondary material collecting unit and is collected therein.

According to the present invention, in a secondary material collecting unit provided with the conveying screw that is driven to rotate about a screw axis extending along the left-right direction, and in a rear partition unit provided between the primary material collecting unit and the secondary material collecting unit, the rear end portion of the grain sieve is located between a vertical line that passes through the peak portion of the rear partition unit and a vertical line that passes through the screw axis in a side view.

Accordingly, processed material that has fallen from the rear end portion of the grain sieve (mixture of grain and straw waste or the like) is less likely to fall forward of the peak portion of the rear partition unit and be collected by the primary material collecting unit, and thus the efficiency of grain recovery is improved.

In the first invention described above, it is preferable that the second chaff sieve extends rearward from a vertical line that passes through a rear end portion of the conveying screw in a side view.

According to the present invention, in the second sorting unit, the rear end portion of the grain sieve and the front end portion of the second chaff sieve are slightly separated in the front-rear direction, and thus processed material (mixture of grain and straw waste or the like) that has reached the rear end portion of the grain sieve is likely to fall from the rear end portion of the grain sieve, and the collection efficiency of the secondary material collecting unit is improved.

In the first invention described above, it is preferable that the straw rack extends rearward such that a rear end portion of the straw rack is located above a rear portion of the second chaff sieve.

According to the present invention, in the first sorting unit and the second sorting unit, the straw rack and the second chaff sieve are arranged so as to be overlapped with each other in a plan view. Accordingly, sorted processed material obtained by the straw rack falls from the straw rack, is received by the second chaff sieve, and is sorted by the second chaff sieve, and sorted processed material obtained by the second chaff sieve falls from the second chaff sieve and is collected by the secondary material collecting unit, thus improving the collection efficiency of the secondary material collecting unit.

In the first invention described above, it is preferable that the first grain pan and the first chaff sieve are inclined rearward and upward, and a rearward and upward inclination angle of the first chaff sieve is greater than a rearward and upward inclination angle of the first grain pan.

In the first sorting unit, the first grain pan has a function of conveying the processed material rearward. The first chaff sieve has a function of performing sorting while conveying processed material rearward and allowing processed material to fall to the second sorting unit. In this case, if processed material is conveyed rearward too quickly in the first chaff sieve, the sorting of processed material in the first chaff sieve slows down, and processed material that is to be allowed to fall to the second sorting unit can possibly be conveyed from the first chaff sieve to the straw rack.

According to the present invention, the rearward and upward inclination angle of the first chaff sieve is set higher than the rearward and upward inclination angle of the first grain pan, and thus processed material in the first chaff sieve is conveyed rearward a little more slowly. Accordingly, in the first chaff sieve, the sorting of processed material that is to be allowed to fall to the second sorting unit slows down, processed material that is to be allowed to fall to the second sorting unit is less likely to be conveyed from the first chaff sieve to the straw rack, and the efficiency of grain recovery is improved.

In the first invention described above, it is preferable that the threshing unit includes: a threshing cylinder that is configured to be driven to rotate about a rotation axis extending in a front-rear direction and includes a raking unit configured to rake a harvested crop rearward and a threshing processing unit that is continuous with a rear portion of the raking unit and is configured to thresh the crop, and a receiving net arranged below the threshing processing unit, the raking unit is provided at a front portion of the threshing cylinder so as to project forward of a front end portion of a grain fan case covering an outward side of the grain fan, a front end portion of the receiving net and the front end portion of the grain fan case are located at the same position in a front-rear direction, and the first grain pan extends forward between the receiving net and the grain fan case such that a front end portion of the first grain pan is located at the same position as the front end portion of the grain fan case in the front-rear direction.

In the threshing unit that includes a threshing cylinder and a receiving net, a large amount of the crop is threshed in the front portion of the threshing unit to which the reaped crop is introduced, and a large amount of processed material falls from the front portion of the threshing unit to the first grain pan of the first sorting unit.

According to the present invention, the raking unit of the threshing cylinder protrudes forward beyond the front end portion of the grain fan case that covers the outward side of the grain fan, and the space between the receiving net and the grain fan case is utilized to allow the first grain pan to be extended in the front-rear direction, and therefore even if a large amount of processed material falls from the threshing unit to the first grain pan, the processed material is efficiently conveyed rearward by the first grain pan.

Second Invention

A threshing apparatus according to a second embodiment includes: a threshing unit configured to thresh a harvested crop; a first sorting unit that is arranged below the threshing unit, includes a first sieve case, and is configured to perform sorting processing on a processed material from the threshing unit; a second sorting unit that is arranged below the first sorting unit, includes a second sieve case, and is configured to perform sorting processing on a processed material from the first sorting unit; a grain fan that is arranged below a front end of the threshing unit and is configured to supply sorting wind; and a first air passage configured to guide sorting wind from the grain fan to a space between the first sorting unit and the second sorting unit.

According to the present invention, a harvested crop is threshed in the threshing unit, and the processed material falls to the first sorting unit therebelow and is subjected to sorting. In the first sorting unit, the processed material is sorted into grain that is to be collected and straw waste or the like that is to be discharged, and the grain and some of the straw waste or the like falls to the second sorting unit therebelow, and much of the straw waste or the like is discharged. In the second sorting unit, the processed material is sorted into grain that is to be collected and straw waste or the like that is to be discharged, and the grain is collected and the straw waste or the like is discharged.

According to the present invention, the processed material from the threshing unit is sorted in two stages by the first sorting unit and the second sorting unit, and therefore compared with a configuration in which processed material from the threshing unit is sorted by one large sorting unit that has a large area in a plan view, more processed material from the threshing unit can be efficiently sorted, and the sorting capability of the threshing apparatus is improved.

In general, sorting wind from the grain fan may flow upward relative to the sorting unit, and therefore if the first sorting unit and the second sorting unit are arranged above/below each other, it is possible that less sorting wind will be supplied from the grain fan to the first sorting unit on the upper side.

According to the present invention, a first air passage is provided for guiding the sorting wind from grain fan to the space between the first sorting unit and the second sorting unit, and a sufficient amount of sorting wind is supplied from grain fan to the first sorting unit, and therefore sorting is stably performed in the first sorting unit and the second sorting unit.

In the second invention described above, it is preferable that a front portion of the first sorting unit extends forward such that the front portion of the first sorting unit is located forward of a front portion of the second sorting unit, and the grain fan is arranged at a location that is below the front portion of the first sorting unit and forward of the front portion of the second sorting unit.

According to the present invention, the grain fan is arranged below the front portion of the first sorting unit, and is arranged forward of the front portion of the second sorting unit, and therefore the first air passage is efficiently set extending from the grain fan to the space between the first sorting unit and the second sorting unit.

In the second invention described above, it is preferable that the first sorting unit includes: a first grain pan that is provided in a front portion of the first sorting unit and is configured to convey processed material rearward, and a first chaff sieve that is provided in the first sorting unit so as to extend rearward from a position separated from a rear end portion of the first grain pan by a gap and is configured to perform sorting while conveying processed material rearward and allow processed material to fall downward, and the threshing apparatus further includes a second wind direction member configured to guide sorting wind in the first air passage to the gap.

According to the present invention, the first sorting unit is provided with the first grain pan that conveys processed material rearward and the first chaff sieve that sorts processed material while conveying it rearward and allows the processed material to fall downward, and a gap is formed between the rear end portion of the first grain pan and the front end portion of the first chaff sieve. If the sorting wind from the grain fan is guided between the first sorting unit and the second sorting unit by the first air passage, the sorting wind in the first air passage is guided to the gap between the rear end portion of the first grain pan and the front end portion of the first chaff sieve by the second wind direction member, and flows above the first chaff sieve.

Accordingly, due to the sorting wind that flows above the first chaff sieve, fine straw waste or the like in the processed material that falls from the threshing unit to the first sorting unit can be expected to be sent rearward by the sorting wind instead of falling to the first chaff sieve.

In the second invention described above, it is preferable that a front portion of the first sorting unit extends forward such that the front portion of the first sorting unit is located forward of a front portion of the second sorting unit, the second wind direction member is arranged at a location that is below a front portion of the first sorting unit and forward of a front portion of the second sorting unit, and is inclined rearward and upward, and sorting wind in the first air passage that passes above the second wind direction member is guided to the gap, and sorting wind in the first air passage that passes below the second wind direction member is guided to a space between the first sorting unit and the second sorting unit.

According to the present invention, due to the front portion of the first sorting unit extending forward such that the front portion of the first sorting unit is located forward of the front portion of the second sorting unit, the first air passage is set efficiently, and furthermore, due to the second wind direction member being inclined rearward and upward, sorting wind in the first air passage that passes above the second wind direction member is smoothly guided to the gap between the rear end portion of the first grain pan and the front end portion of the first chaff sieve. At the same time, sorting wind in the first air passage that passes below the second wind direction member is smoothly guided between the first sorting unit and the second sorting unit.

In the second invention described above, it is preferable that sorting wind in the first air passage that passes above the second wind direction member flows along a bottom portion of the first grain pan and is guided to the gap.

The first grain pan is arranged forward of the above-mentioned gap, has a function of conveying processed material rearward, and does not have a function of selecting processed material and allowing it to fall downward. According to the present invention, the sorting wind in the first air passage that passes above the second wind direction member is smoothly guided along the bottom portion of the first grain pan to the above-mentioned gap without passing through the first grain pan and exiting upward.

In the second invention described above, it is preferable that sorting wind in the first air passage that passes below the second wind direction member is guided from a space between the second wind direction member and a wall portion provided at a front end portion of the second sorting unit to a space between the first sorting unit and the second sorting unit.

According to the present invention, the sorting wind in the first air passage passes between the lower surface portion of the second wind direction member and the wall portion of the front end portion of the second sorting unit, and is smoothly guided to the space between the first sorting unit and the second sorting unit.

In the second invention described above, it is preferable that the threshing apparatus further includes: a second air passage configured to guide sorting wind supplied by the grain fan from a space below the second sorting unit to the second sorting unit.

According to the present invention, in addition to the first air passage that guides sorting wind from the grain fan to the space between the first sorting unit and the second sorting unit, a second air passage is also provided to guide sorting wind supplied by the grain fan from the region below the second sorting unit to the second sorting unit, and therefore a sufficient amount of sorting wind is supplied from the grain fan to the first sorting unit and the second sorting unit, and sorting is stably performed in the first sorting unit and the second sorting unit.

In the second invention described above, it is preferable that the threshing apparatus further includes: a first wind direction member configured to branch sorting wind from the grain fan and guide one portion of the sorting wind to the first air passage and another portion of the sorting wind to the second air passage.

According to the present invention, sorting wind from the grain fan is appropriately branched by the first wind direction member, and is guided to the first air passage and the second air passage without excess or deficiency.

In the second invention described above, it is preferable that the threshing apparatus further includes: a primary material collecting unit provided below the second sorting unit, wherein the second sorting unit includes: a second grain pan that is provided in a front portion of the second sorting unit and is configured to convey processed material rearward, and a grain sieve that is provided in the second sorting unit so as to extend rearward from a rear end portion of the second grain pan and is configured to allow sorted processed material to fall to the primary material collecting unit, and sorting wind in the second air passage flows along a bottom portion of the second grain pan and is guided to a bottom portion of the grain sieve.

According to the present invention, the second sorting unit is provided with the second grain pan for conveying processed material rearward and the grain sieve for allowing sorted processed material to fall to the primary material collecting unit. The second grain pan is arranged forward of the grain sieve, has a function of conveying processed material rearward, and does not have a function of sorting processed material and allowing it to fall downward.

According to the present invention, the sorting wind in the second air passage is guided along the bottom portion of the second grain pan to the bottom portion of the grain sieve without passing through the second grain pan and exiting upward. Accordingly, when the sorted processed material falls from the grain sieve to the primary material collecting unit, fine straw waste or the like can be expected to be sent rearward by the sorting wind instead of falling to the primary material collecting unit.

In the second invention described above, it is preferable that the threshing apparatus further includes: a bottom portion that extends rearward from a lower end portion of a grain fan case that covers an outward side of the grain fan; a primary material collecting unit provided at a location that is below the second sorting unit and rearward of a rear end portion of the bottom portion; and a third wind direction member configured to branch sorting wind in the second air passage and guide a portion of the sorting wind along the bottom portion.

According to the present invention, the sorting wind in the second air passage is branched by the third wind direction member, flows along the bottom portion, and is guided to the upper portion of the primary material collecting unit. Accordingly, when sorted processed material falls into the primary material collecting unit, fine straw waste or the like can be expected to be sent rearward by the sorting wind instead of fall into the primary material collecting unit.

In the second invention described above, it is preferable that the threshing apparatus further includes: a fourth wind direction member that is configured to guide sorting wind in the second air passage so as to flow along the bottom portion, and is separated rearward from a rear end portion of the third wind direction member by a gap, wherein the rear end portion of the third wind direction member extends downward, and a rear end portion of the fourth wind direction member extends downward, and sorting wind flowing along the bottom portion flows in a space between the third wind direction member and the bottom portion and in a space between the fourth wind direction member and the bottom portion, and is guided to an upper portion of the primary material collecting unit.

In the case where sorting wind is branched from the second air passage by the third wind direction member as described above, according to the present invention, sorting wind branched from the second air passage is also guided by the fourth wind direction member that is arranged rearward of the third wind direction member, and the sorting wind branched from the second air passage is smoothly guided between the third wind direction member and the bottom portion and between the fourth wind direction member and the bottom portion to the upper portion of the primary material collecting unit.

According to the present invention, the rear end portion of the third wind direction member extends downward, and the rear end portion of the fourth wind direction member extends downward, and therefore the case where sorting wind branched from the second air passage moves upward away from the bottom portion is suppressed, and sorting wind branched from the second air passage is smoothly guided to the upper portion of the primary material collecting unit.

According to the present invention, a space is provided between the third wind direction member and the fourth wind direction member, and it can be expected that when sorting wind branched from the second air passage passes from the space between the third wind direction member and the bottom portion and through the space between the fourth wind direction member and the bottom portion, air from the space between the third wind direction member and the fourth wind direction member merges with sorting wind branched from the second air passage. This therefore suppresses the case where an insufficient amount of sorting wind is guided to the upper portion of the primary material collecting unit.

Third Invention

A threshing apparatus according to a third embodiment includes: a threshing unit configured to thresh a harvested crop; a first sorting unit that is disposed below the threshing unit, is supported so as to be reciprocally drivable along a front-rear direction, and is configured to perform sorting on a processed material from the threshing unit; a second sorting unit that is disposed below the first sorting unit, is supported so as to be reciprocally drivable along the front-rear direction, and is configured to perform sorting on a processed material from the first sorting unit; and a first drive mechanism and a second drive mechanism that are configured to separately drive the first sorting unit and the second sorting unit to reciprocate.

According to the present invention, a harvested crop is threshed in the threshing unit, and processed material falls to the first sorting unit therebelow and is subjected to sorting. In the first sorting unit, processed material is sorted into grain that is to be collected and straw waste or the like that is to be discharged, and the grain and some of the straw waste or the like falls to the second sorting unit therebelow, and much of the straw waste or the like is discharged. In the second sorting unit, processed material is sorted into grain that is to be collected and straw waste or the like that is to be discharged, and the grain is collected and the straw waste or the like is discharged.

According to the present invention, processed material from the threshing unit is sorted in two stages by the first sorting unit and the second sorting unit, and therefore compared with a configuration in which processed material from the threshing unit is sorted by one large sorting unit that has a large area in a plan view, more processed material from the threshing unit can be efficiently sorted, and the sorting capability of the threshing apparatus is improved.

According to the present invention, the first sorting unit is driven to reciprocate by the first drive mechanism, and the second sorting unit is driven to reciprocate by the second drive mechanism. Alternatively, the first sorting unit is driven to reciprocate by the second drive mechanism, and the second sorting unit is driven to reciprocate by the first drive mechanism.

Accordingly, compared with a configuration in which the first sorting unit and the second sorting unit are driven to reciprocate by one drive mechanism, a smaller load is applied to the first drive mechanism and a smaller load is applied to the second drive mechanism, and this configuration is advantageous in terms of improving the durability of the first drive mechanism and the second drive mechanism.

In the third invention described above, it is preferable that the first sorting unit and the second sorting unit are driven to reciprocate in mutually opposite directions.

According to the present invention, when the first sorting unit is driven forward, the second sorting unit is driven rearward, and when the first sorting unit is driven rearward, the second sorting unit is driven forward. Accordingly, vibration caused by the reciprocating of the first sorting unit and vibration caused by the reciprocating of the second sorting unit cancel each other out, and vibration caused by the first sorting unit and the second sorting unit is suppressed.

In the third invention described above, it is preferable that one sorting unit out of the first sorting unit and the second sorting unit is driven to reciprocate by the first drive mechanism, and reciprocating driving of the one sorting unit is transmitted via the second drive mechanism to an other sorting unit out of the first sorting unit and the second sorting unit such that the other sorting unit is driven to reciprocate.

According to the present invention, the first sorting unit is driven to reciprocate by the first drive mechanism, and the second sorting unit is driven to reciprocate by the first sorting unit and the second drive mechanism. Alternatively, the second sorting unit is driven to reciprocate by the first drive mechanism, and the first sorting unit is driven to reciprocate by the second sorting unit and the second drive mechanism.

Accordingly, motive power is transmitted from the first drive mechanism to the second sorting unit via the first sorting unit and the second drive mechanism. Alternatively, motive power is transmitted from the first drive mechanism to the first sorting unit through the second sorting unit and the second drive mechanism, thus flowing in series like the flow of a single river, and this configuration is advantageous in terms of simplifying the structure of the first drive mechanism and the second drive mechanism.

In the third invention described above, it is preferable that the second drive mechanism is a drive arm that extends to one side and to an other side from an arm axis extending along a left-right direction, and is supported so as to be reciprocally swingable around the arm axis, one portion of the drive arm on one side of the arm axis is connected to the first sorting unit, and another portion of the drive arm on an other side of the arm axis is connected to the second sorting unit, due to one sorting unit out of the first sorting unit and the second sorting unit being driven to reciprocate by the first drive mechanism, the drive arm is driven to swing reciprocally, and an other sorting unit out of the first sorting unit and the second sorting unit is driven to reciprocate, and the first sorting unit and the second sorting unit are driven to reciprocate in mutually opposite directions.

According to the present invention, for example, when the drive arm is swung to one side, the first sorting unit is driven forward, and the second sorting unit is driven rearward, whereas when the drive arm swings to the other side, the first sorting unit is driven rearward, and the second sorting unit is driven forward. Accordingly, a structure in which the first sorting unit and the second sorting unit are driven to reciprocate in opposite directions is achieved simply by the drive arm, and this configuration is advantageous in terms of simplification of the structure.

In the third invention described above, it is preferable that the first drive mechanism is a drive member that is supported so as to be reciprocally swingable around an axis extending along the left-right direction, and is connected to one sorting unit out of the first sorting unit and the second sorting unit, and the threshing apparatus further includes an elastic body provided on at least one out of: a connection portion between the drive member and either the first sorting unit or the second sorting unit, and a connection portion between the drive arm and either the first sorting unit or the second sorting unit.

According to the present invention, the first drive mechanism is a drive member that is driven to reciprocally swing around an axis extending along the left-right direction and is connected to either the first sorting unit or the second sorting unit, and this configuration is advantageous in terms of simplifying the structure of the first drive mechanism.

For example, in the case where the drive member is connected to the first sorting unit, assume that the movement path of the portion of the drive member that is connected to the first sorting unit and the movement path of the portion of the drive arm that is connected to the first sorting unit are slightly different due to the positional relationship between the axis of the drive member and the arm axis of the drive arm for example.

In this state, according to the present invention, an elastic body is provided on at least one out of the connection portion between the drive member and the first sorting unit and the connection portion between the drive arm and the first sorting unit, and the difference between the movement paths is absorbed by elastic deformation of the elastic body, and thus the reciprocating swinging of the drive member and the reciprocating swinging of the drive arm are performed smoothly.

As another example, in the case where the drive member is connected to the second sorting unit, assume that the movement path of the portion of the drive member that is connected to the second sorting unit and the movement path of the portion of the drive arm that is connected to the second sorting unit are slightly different due to the positional relationship between the axis of the drive member and the arm axis of the drive arm for example.

In this state, according to the present invention, an elastic body is provided on at least one out of the connection portion between the drive member and the second sorting unit and the connection portion between the drive arm and the second sorting unit, and the difference between the movement paths is absorbed by elastic deformation of the elastic body, and thus the reciprocating swinging of the drive member and the reciprocating swinging of the drive arm are performed smoothly.

In the third invention described above, it is preferable that the threshing apparatus further includes: at least one out of: a member length adjusting portion configured to adjust the length of the drive member from the axis to a connection portion connected to either the first sorting unit or the second sorting unit, and an arm length adjusting portion configured to adjust the length of the drive arm from the arm axis to a connection portion connected to either the first sorting unit or the second sorting unit.

According to the present invention, in the case where the drive member is connected to the first sorting unit for example, the member length adjusting portion is provided for adjusting the length of the drive member from the axis to the portion connected to the first sorting unit, and/or the arm length adjusting portion is provided for adjusting the length of the drive arm from the arm axis to the portion connected to the first sorting unit.

Accordingly, if the movement path of the portion of the drive member connected to the first sorting unit and the movement path of the portion of the drive arm connected to the first sorting unit are slightly different as described above, not only due to the above-described elastic body, but also if a worker adjusts one or both of the member length adjusting portion and the arm length adjusting portion, the difference between the movement paths is efficiently absorbed, and the reciprocating swinging of the drive member and the reciprocating swinging of the drive arm are performed smoothly.

According to the present invention, in the case where the drive member is connected to the second sorting unit for example, the member length adjusting portion is provided for adjusting the length of the drive member from the axis to the portion connected to the second sorting unit, and/or the arm length adjusting portion is provided for adjusting the length of the drive arm from the arm axis to the portion connected to the second sorting unit.

Accordingly, if the movement path of the portion of the drive member connected to the second sorting unit and the movement path of the portion of the drive arm connected to the second sorting unit are slightly different as described above, not only due to the above-described elastic body, but also if a worker adjusts one or both of the member length adjusting portion and the arm length adjusting portion, the difference between the movement paths is efficiently absorbed, and the reciprocating swinging of the drive member and the reciprocating swinging of the drive arm are performed smoothly.

In the third invention described above, it is preferable that the threshing apparatus further includes: a wear prevention member arranged in at least one out of: a space between the drive member and a side wall that covers an outward side of the first sorting unit and the second sorting unit, and a space between the drive arm and either the first sorting unit or the second sorting unit.

For example, in the case where a side wall covering the outward side of the first sorting unit and the second sorting unit is arranged close to the drive member, or if the drive arm and the first sorting unit (second sorting unit) are arranged close to each other, according to the present invention, the wearing of the side wall and the drive member caused by contact between the side wall and the drive member is prevented by the wear prevention member, and the wearing of the drive arm and the first sorting unit (second sorting unit) caused by contact between the drive arm and the first sorting unit (second sorting unit) is prevented by the wear prevention member.

Fourth Invention

A threshing apparatus according to a fourth embodiment includes: a threshing unit configured to thresh a harvested crop, a sorting unit that is arranged below the threshing unit and is configured to perform sorting on a processed material from the threshing unit, and a grain fan that is arranged forward of the sorting unit and is configured to supply sorting wind to the sorting unit, the threshing unit, the sorting unit, and the grain fan being arranged between left and right side walls; and wind direction members configured to guide sorting wind, which is from the grain fan and flows along the side walls, toward a lateral center region between the left and right side walls.

According to the present invention, in the case where sorting wind from the grain fan is supplied to the sorting unit from between the right and left side walls, sorting wind from the grain fan that flows along the side walls is guided by the wind direction members to the lateral center region between the left and right side walls, thus suppressing the supply of sorting wind from the grain fan to regions close to the side walls in the sorting unit, and obtained sufficient supply of sorting wind from the grain fan to the lateral center region in the sorting unit. Accordingly, sorting wind from the grain fan is easily supplied uniformly in the left-right direction in the sorting unit, sorting is performed uniformly in the left-right direction in the sorting unit, and the sorting performance of the sorting unit is improved.

In the fourth invention described above, it is preferable that the wind direction members are each shaped as a flat plate having many openings, and are each arranged in an inclined orientation in which a rear portion of the wind direction member is closer to the lateral center region than a front portion of the wind direction member.

According to the present invention, the wind direction members are each shaped as a flat plate arranged in an inclined orientation in which a rear portion of the wind direction member is closer to the lateral center region between the left and right side walls than a front portion of the wind direction member, and the wind direction members have a simple configuration.

If the wind direction members have a simple flat plate shape, it is possible that too much of the sorting wind from the grain fan that flows along the side walls is guided by the wind direction members toward the lateral center region between the left and right side walls, and that too little sorting wind is supplied from the grain fan to regions near the side walls in the sorting unit.

According to the present invention, the wind direction members are each shaped as a flat plate having many openings, and therefore sorting wind from the grain fan that flows along the side walls can be divided by the wind direction members into sorting wind that is guided toward the lateral center region between the left and right side walls and sorting wind that flows through the wind direction members and along the side walls. Accordingly, it is possible to suppress the case where too much of the sorting wind from the grain fan that flows along the side wall is guided toward the lateral center region between the left and right side walls by the wind direction members, and sorting wind from the grain fan is easily supplied uniformly in the left-right direction in the sorting unit.

In the fourth invention described above, it is preferable that one of the wind direction members is a right wind direction member configured to guide sorting wind, which is from the grain fan and flows along the right side wall, toward the lateral center region between the left and right side walls, and another one of the wind direction members is a left wind direction member configured to guide sorting wind, which is from the grain fan and flows along the left side wall, toward the lateral center region between the left and right side walls.

According to the present invention, even when sorting wind from the grain fan flows along both the right and left side walls, due to the right and left wind direction members, the sorting wind from the grain fan flowing along the right and left side walls is guided toward the lateral center region between the left and right side walls, and thus sorting wind from the grain fan is easily supplied uniformly in the left-right direction in the sorting unit.

In the fourth invention described above, it is preferable that the threshing apparatus further includes: an upper wind direction member that extends between the left and right side walls and is configured to guide sorting wind from the grain fan to the sorting unit; and a lower wind direction member that extends between the left and right side walls, is arranged below the upper wind direction member, and is configured to guide sorting wind from the grain fan to the sorting unit, wherein the wind direction members are arranged between the upper wind direction member and the lower wind direction member.

According to the present invention, the upper wind direction member and the lower wind direction member are provided, and thus by appropriately setting the directions of the upper wind direction member and the lower wind direction member, sorting wind from the grain fan can be easily supplied to appropriate positions in the front-rear direction in the sorting unit, sorting wind is easily supplied uniformly in the front-rear direction in the sorting unit, and the sorting performance of the sorting unit is improved.

According to the present invention, wind direction members are arranged between the upper wind direction member and the lower wind direction member, and sorting wind from the grain fan that flows along the side walls is easily guided toward the wind direction members by the upper wind direction member and the lower wind direction member, and thus the wind direction members can efficiently guide sorting wind from the grain fan that flows along the side walls toward the lateral center region between the left and right side walls.

In the fourth invention described above, it is preferable that the wind direction members are coupled to the upper wind direction member and the lower wind direction member.

According to the present invention, the wind direction members are coupled to the upper wind direction member and the lower wind direction member and supported by the upper wind direction member and the lower wind direction member, and thus this configuration is advantageous in terms of simplifying the support structure for the wind direction members.

In the fourth invention described above, it is preferable that the threshing apparatus further includes: a reinforcing member coupled to an outer surface portion of one side wall out of the left and right side walls; and a rotation speed changing portion that is configured to change an air volume of sorting wind from the grain fan by changing a rotation speed of the grain fan, and is supported by the reinforcing member, wherein at least one wind direction member out of the upper wind direction member and the lower wind direction member extends between an inner surface portion that faces the reinforcing member on the one side wall to which the reinforcing member is coupled and an inner surface portion that faces the reinforcing member on an other one of the left and right side walls.

According to the present invention, a reinforcing member is coupled to an outer surface portion of one side wall out of the left and right side walls, and furthermore at least one wind direction member out of the upper wind direction member and the lower wind direction member extends between an inner surface portion that faces the reinforcing member on the one side wall to which the reinforcing member is coupled and an inner surface portion that faces the reinforcing member on an other one of the left and right side walls. Accordingly, one of the left and right side walls is reinforced by the reinforcing member and at least either the upper wind direction member or the lower wind direction member or both of them.

According to the present invention, in the case where the rotation speed changing portion for changing the rotation speed of the grain fan is provided, the rotation speed changing portion is supported by the reinforcing member, and thus the rotation change portion is easily supported by the reinforcing member and the one side wall that is reinforced by at least either the upper wind direction member or the lower wind direction member or both of them.

Fifth Invention

A threshing apparatus according to a fifth embodiment includes: a threshing unit configured to thresh a harvested crop; a sorting unit that includes a chaff sieve in which many chaff lips extending along a left-right direction are arranged side by side along a front-rear direction, is arranged below the threshing unit, and is configured to perform sorting on a processed material from the threshing unit; a gap changing portion configured to operate the chaff lips toward an open state such that the size of a gap between adjacent chaff lips increases, and toward a closed state such that the size of the gap decreases; a coil spring configured to bias the gap changing portion toward one state out of the open state and the closed state by extending from a compressed state relative to a free length of the coil spring; and an actuator and a wire that is connected to and extends between the actuator and the gap changing portion, wherein due to the wire being pulled toward the actuator by the actuator, the gap changing portion is operated toward an other state out of the open state and the closed state in resistance against the coil spring.

According to the present invention, the threshing apparatus includes a coil spring configured to bias the gap changing portion toward either the open state or the closed state by extending from a compressed state relative to a free length of the coil spring. When the wire is pulled toward the actuator, the coil spring is compressed and the gap changing portion is operated toward either the open state or the closed state. When the wire is returned toward the gap changing portion, the coil spring extends and pushes the gap changing portion, and thus the gap changing portion is operated toward either the open state or the closed state.

According to the present invention, the coil spring that operates the gap changing portion repeatedly becomes compressed and stressed, and even if a hook portion is not formed at one end portion of the coil spring and the other end portion thereof, the coil spring easily becomes compressed and extended. In this way, it is not necessary to form the hook portion at one end portion and the other end portion of the coil spring, the hook portion is not likely to become damaged, and the durability of the coil spring is improved.

In the fifth invention described above, it is preferable that the gap changing portion is biased toward the open state by the coil spring, and due to the wire being pulled toward the actuator by the actuator, the gap changing portion is operated toward the closed state in resistance against the coil spring.

In threshing apparatuses of recent years, an improvement in threshing performance in the threshing unit has made it possible to thresh a large amount of crop, and it has become necessary for the sorting unit to perform sorting on a large amount of processed material. According to the present invention, the gap changing portion is biased toward the open state by the coil spring, and the state in which the gap changing portion is operated toward the open state is prioritized over the state in which the gap changing portion is operated toward the closed state, thus obtaining a chaff sieve suitable for a state in which a large amount of processed material is sorted in the sorting unit.

In the fifth invention described above, it is preferable that the gap changing portion is supported so as to be swingable around a swing axis, and the coil spring and the wire are both connected to one portion of the gap changing portion that extends from the swing axis, and are arranged side by side so as to extend along each other.

According to the present invention, the coil spring and the wire are arranged close to each other due to being connected to the same portion that extends from the swing axis in the gap changing portion, and also due to being arranged side by side with each other, and this configuration is advantageous in terms of compactness in the vicinity of the gap changing portion, the coil spring, and the wire.

In the fifth invention described above, it is preferable that the coil spring and the wire are both connected to a common connecting portion provided in the gap changing portion.

According to the present invention, the coil spring and the wire are connected to the same connecting portion provided in the gap changing portion, and this configuration is advantageous in terms of simplification of the structure.

In the fifth invention described above, it is preferable that the threshing apparatus further includes: a boss portion connected to the gap changing portion, and a rod portion that is connected to the sorting unit and is slidably inserted into the boss portion, wherein the rod portion is inserted into the coil spring, and the coil spring is provided between the boss portion and a spring receiving portion provided on the rod portion, and the gap changing portion is biased via the boss portion due to the coil spring attempting to extend from the compressed state relative to the free length.

In the case where the coil spring is configured to be compressed, it is necessary to avoid a state in which the coil spring buckles and bends. According to the present invention, the rod portion is inserted into the coil spring, and the coil spring is supported by the boss portion, the rod portion, and the spring receiving portion, and the coil spring is compressed by the boss portion and the spring receiving portion of the rod portion. Accordingly, the rod portion prevents the coil spring from buckling and bending, and the coil spring can be easily compressed.

### BRIEF DESCRIPTION OF THE DRAWINGS

FIG. 1 is a left side view of a combine.

FIG. 2 is a left side view of a threshing apparatus.

FIG. 3 is a right side view of the threshing apparatus.

FIG. 4 is a vertical sectional left side view of the threshing apparatus.

FIG. 5 is a vertical sectional left side view of a region including a grain fan.

FIG. 6 is a vertical sectional left side view of a region including a secondary material collection unit.

FIG. 7 is a vertical sectional rear view of a region including first, third, and sixth wind direction members.

FIG. 8 is a left side view showing a structure for changing a chaff lip gap in a first chaff sieve.

FIG. 9 is a vertical sectional front view showing the structure for changing the chaff lip gap in the first chaff sieve.

FIG. 10 is a vertical sectional left side view of a region including a rear wall portion of a rear end portion of a second sieve case and a region including a connection portion between a drive arm and a second sorting unit.

FIG. 11 is an exploded perspective view of a guide member and the rear wall portion of the rear end portion of the second sieve case.

FIG. 12 is a perspective view of a region including a grain fan case as viewed from below.

FIG. 13 is a left side view of a region including the grain fan.

FIG. 14 is a left side view showing a rotation speed changing portion of the grain fan.

FIG. 15 is a diagram showing a transmission system for transmitting power from an engine to a threshing cylinder, a first sorting unit, and a second sorting unit.

FIG. 16 is a left side view showing a transmission chain and a tension wheel body that transmit motive power from the engine to the first sorting unit and the second sorting unit.

FIG. 17 is a rear view showing a structure that drives the first sorting unit and the second sorting unit to reciprocate along the front-rear direction.

FIG. 18 is a left side view showing the structure that drives the first sorting unit and the second sorting unit to reciprocate along the front-rear direction.

FIG. 19 is an exploded perspective view of a drive member.

FIG. 20 is a vertical sectional left side view of the drive arm.

FIG. 21 is a left side view showing reciprocating driving of the first sorting unit and the second sorting unit.

FIG. 22 is a left side view showing reciprocating driving of the first sorting unit and the second sorting unit.

### DESCRIPTION OF THE INVENTION

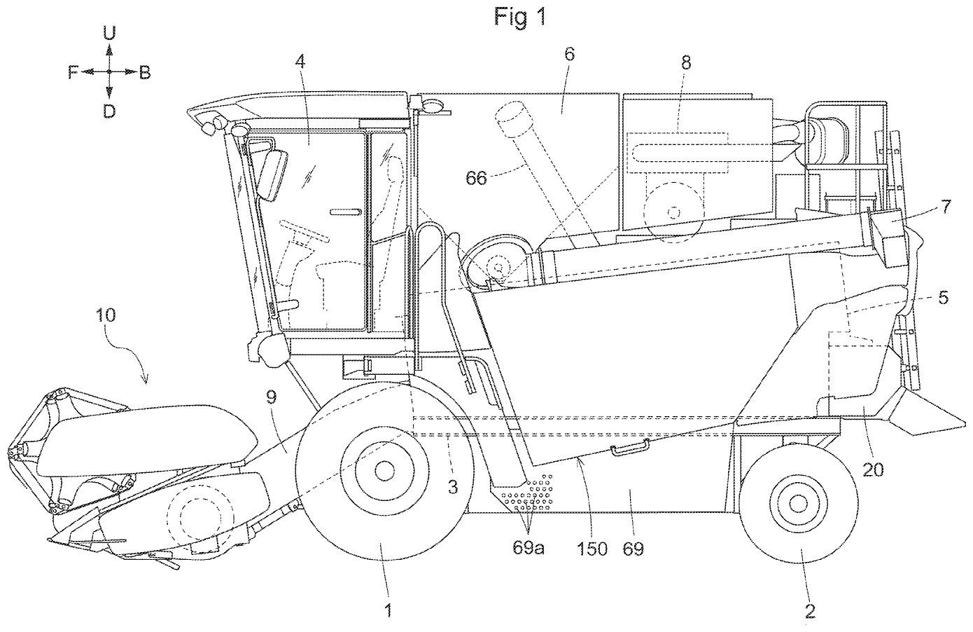

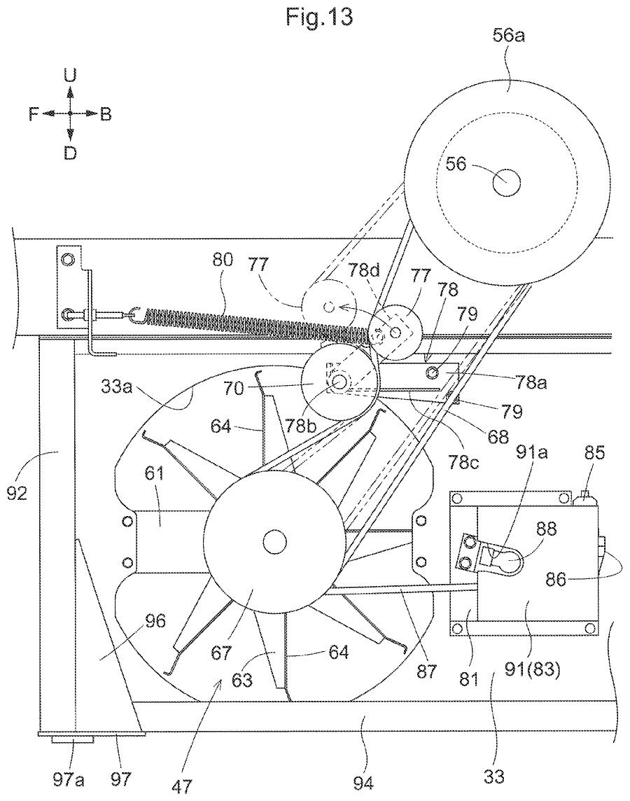

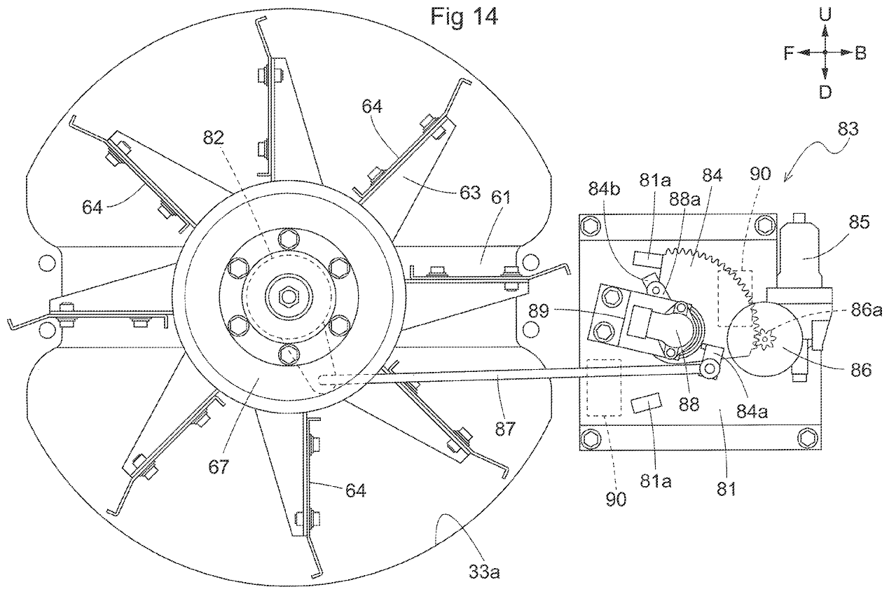

FIGS. 1 to 22 show a normal-type combine equipped with a threshing apparatus of the present invention, where F indicates the forward direction, B indicates the rearward direction, U indicates the upward direction, D indicates the downward direction, R indicates the rightward direction, and L indicates the leftward direction.

Overall Configuration of Combine

As shown in FIG. 1, right and left front wheels 1 are supported by front portions of right and left body frames 3 that extend along the front-rear direction, and right and left rear wheels 2 are supported by rear portions of the body frames 3. A driver portion 4 is provided at a front portion of the body frames 3, and a threshing apparatus 150 is provided on the body frames 3.

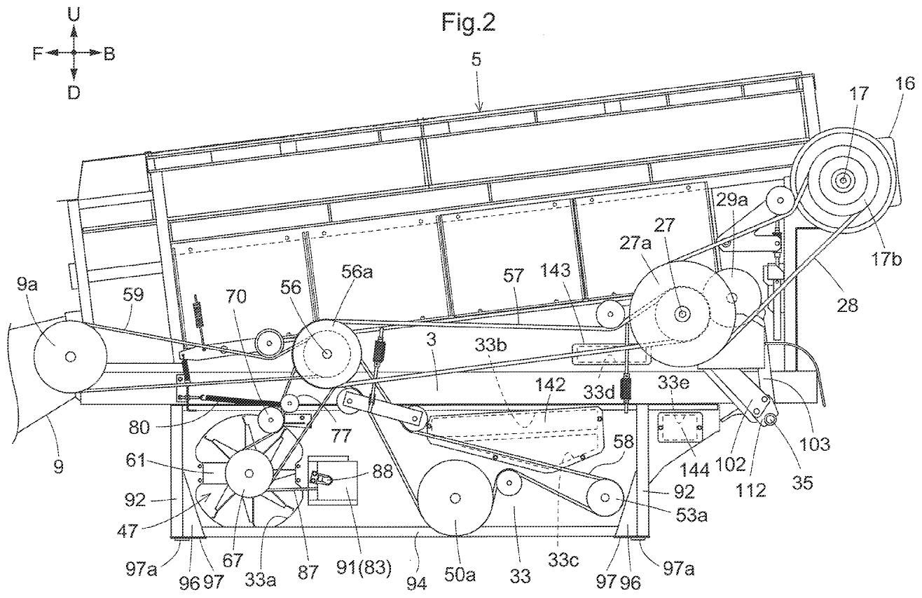

As shown in FIGS. 2, 3, and 4, the threshing apparatus 150 includes a threshing unit 5, a first sorting unit 11, a second sorting unit 12, and the like that are provided between right and left side walls 33.

As shown in FIG. 1, a grain tank 6 is provided above a front portion of the threshing unit 5, the grain tank 6 includes an unloader 7, and an engine 8 is provided above a rear portion of the threshing unit 5. A feeder 9 is provided in front of the threshing unit 5 and extends forward, and a reaping unit 10 is connected to a front portion of the feeder 9.

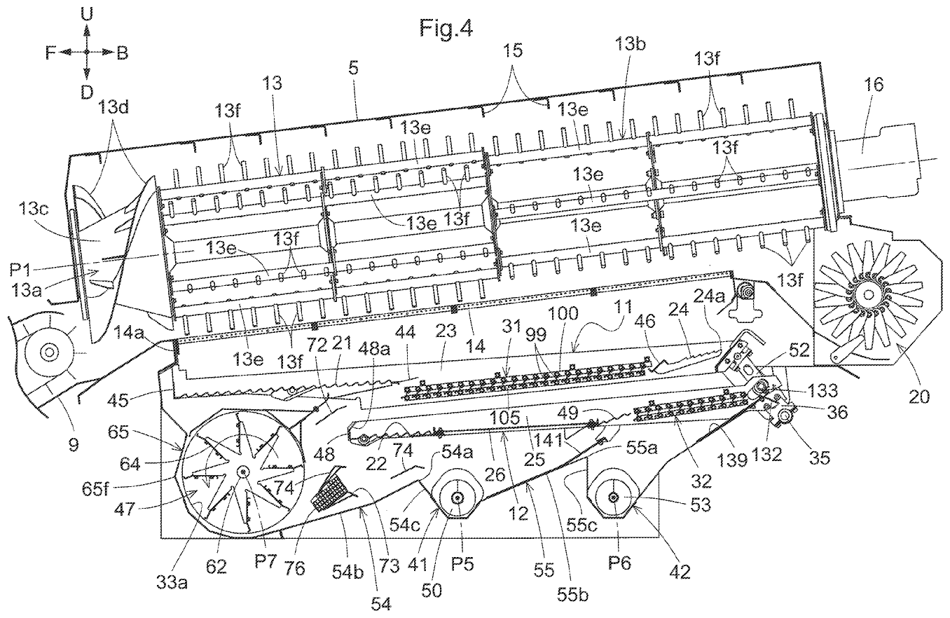

As shown in FIG. 4, the first sorting unit 11 is provided below the threshing unit 5. The second sorting unit 12 is provided below the first sorting unit 11. A primary material collecting unit 41 is provided below the second sorting unit 12. The secondary material collecting unit 42 is provided at a location that is below the second sorting unit 12 and rearward of the primary material collecting unit 41. A grain fan 47 that supplies sorting wind to the first sorting unit 11 and the second sorting unit 12 is provided at a location that is below a front portion of the threshing unit 5 and forward of the primary material collecting unit 41.

As shown in FIGS. 1 and 4, a crop in a field is reaped and harvested by the reaping unit 10 and supplied to the threshing unit 5 through the feeder 9. The harvested crop is threshed by the threshing unit 5, and the processed material from the threshing unit 5 is sorted by the first sorting unit 11 and the second sorting unit 12.

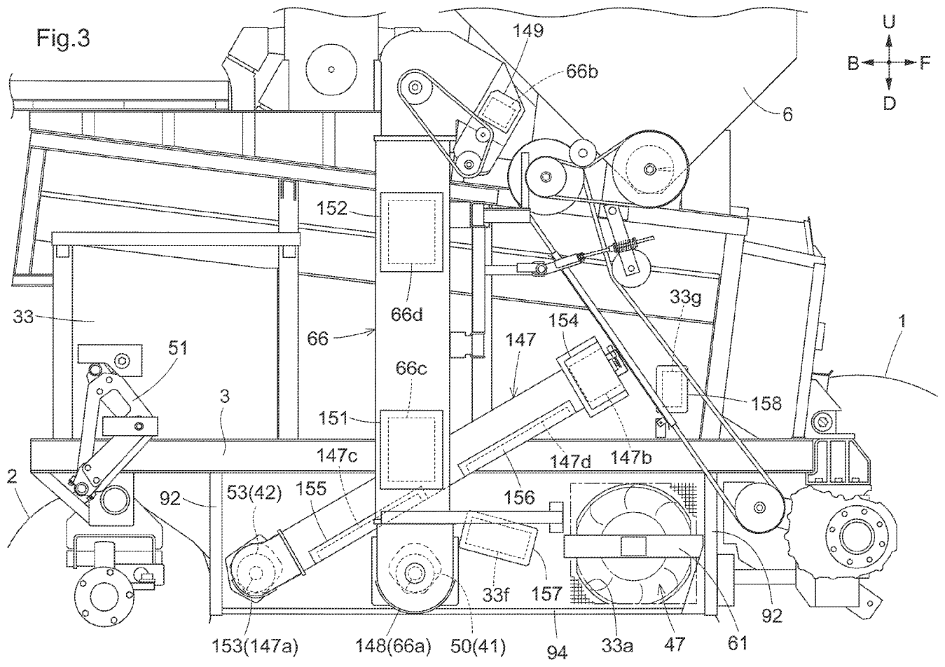

As shown in FIGS. 1 and 3, grain obtained as the sorted processed material is collected by the primary material collecting unit 41 from the second sorting unit 12 and is supplied to the grain tank 6 by a conveying apparatus 66. A mixture of grain, straw waste, and the like obtained as the sorted processed material is collected by the secondary material collecting unit 42 from the second sorting unit 12 and supplied to the front portion of the first sorting unit 11 by a conveying apparatus 147 and sorted again.

When the grain tank 6 is full of grain, the reaping work is temporarily suspended, the grain in the grain tank 6 is discharged to another transport vehicle (not shown) by the unloader 7, and then the reaping work is restarted.

Configuration of Threshing Unit

As shown in FIG. 4, the threshing unit 5 is provided with a threshing cylinder 13 that is rotationally driven around a rotation axis P1 extending along the front-rear direction, as well as a receiving net 14, a dust discharge valves 15, and the like. The threshing cylinder 13 and the receiving net 14 are arranged with a rearward and upward inclination, and the dust discharge valves 15 are provided above the threshing cylinder 13.

The threshing cylinder 13 is provided with a raking unit 13a for raking the reaped crop rearward, a threshing processing unit 13b that is continuous with a rear portion of the raking unit 13a and threshes the crop, and the like.

The raking unit 13a of the threshing cylinder 13 includes a conical main body portion 13c, and a spiral portion 13d connected to the outer peripheral portion of the main body portion 13c, for example.

The threshing processing unit 13b of the threshing cylinder 13 includes a plurality of round pipe-shaped threshing tooth support portions 13e arranged along the rotation axis P1, and a large number of round bar-shaped threshing teeth 13f that extend radially outward from the threshing tooth support portions 13e, for example.

The receiving net 14 has a large number of lattices formed by a large number of semicircular members that extend along the rotation direction of the threshing cylinder 13 and a large number of rod members that extend along the rotation axis P1.

The receiving net 14 is arranged below the threshing processing unit 13b of the threshing cylinder 13, and has a semi-cylindrical shape extending along the threshing processing unit 13b of the threshing cylinder 13.

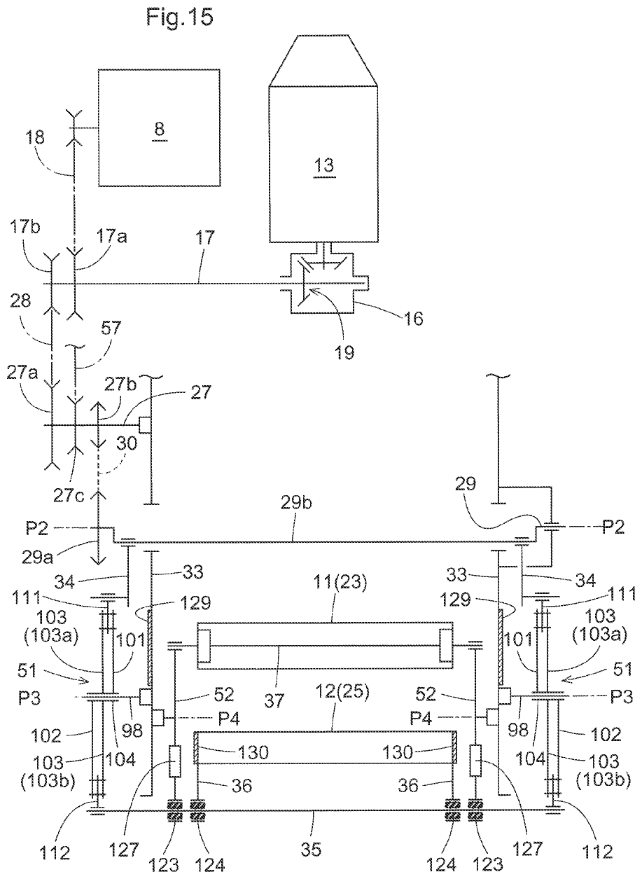

As shown in FIGS. 4 and 15, a drive case 16 is connected to a rear portion of the threshing unit 5, and a transmission shaft 17 protrudes to the left from the drive case 16. Motive power from the engine 8 is transmitted from a pulley 17a connected to a left portion of a transmission shaft 17 to the transmission shaft 17 via a transmission belt 18, and is then transmitted to the threshing cylinder 13 via a bevel gear mechanism 19 inside the drive case 16, and the threshing cylinder 13 is rotationally driven around the rotation axis P1.

As a result, the crop reaped by the reaping unit 10 is conveyed toward the threshing unit 5 by the feeder 9, is raked rearward by the raking unit 13a of the threshing cylinder 13, and is introduced into the threshing unit 5. The crop is threshed by the threshing cylinder 13 and the receiving net 14, and is sent rearward by the guiding action of the dust discharge valves 15.

Processed material such as grain and straw waste passes through the receiving net 14 and falls to the first sorting unit 11 therebelow. The straw waste and the like that reaches the rear portion of the threshing unit 5 without falling downward through the receiving net 14 is shredded by a shredding apparatus 20 and discharged to the field.

Configuration of Right and Left Side Walls

As shown in FIGS. 2, 3, and 4, the threshing unit 5 is arranged between right and left side walls 33, and the right and left side walls 33 extend below the threshing unit 5 and have the following configuration.

As shown in FIGS. 2, 3, 12, and 13, four support column members 92 are provided, namely two square pipe-shaped support column members 92 that are coupled to and extend downward from a front portion and a rear portion of the right body frame 3, and two square pipe-shaped support column members 92 that are coupled to and extend downward from a front portion and a rear portion of the left body frame 3.

A horizontal frame 93 is coupled to and extends between lower portions of the right and left support column members 92 on the front side, and a horizontal frame 93 is coupled to and extends between lower portions of the right and left support column members 92 on the rear side. A horizontal frame 94 is coupled to and extends between lower portions of the front and rear support column members 92 on the right side, and a horizontal frame 94 is coupled to and extends between lower portions of the front and rear support column members 92 on the left side.

The right side wall 33 is coupled to and extends between the right body frame 3, the front and rear support column members 92 on the right side, and the right horizontal frame 94, and the left side wall 33 is coupled to and extends between the left body frame 3, front and rear support column members 92 on the left side, and the left horizontal frame 94. The outward sides of the threshing unit 5, the first sorting unit 11, and the second sorting unit 12 are covered by the right and left side walls 33.

The configuration described below is provided at a lower portion of each of the four support column members 92.

A bottom plate 97, to which a ring member 97a is coupled, is coupled to and extends between a lower end portion of the support column member 92 and the horizontal frames 93 and 94. A triangular rib 95 is coupled to and extends between the support column member 92 and the horizontal frame 93. A triangular rib 96 is coupled to and extends between the support column member 92, the horizontal frame 94, and the bottom plate 97.

A jack (not shown) can be placed against the bottom of the bottom plate 97, and the combine can be lifted by the jack. The right and left bottom plates 97 on the front side are mainly used when replacing the front wheels 1 or when removing the transmission case (not shown). The right and left bottom plates 97 on the rear side are mainly used when replacing the rear wheels 2.

Configuration of First Sorting Unit

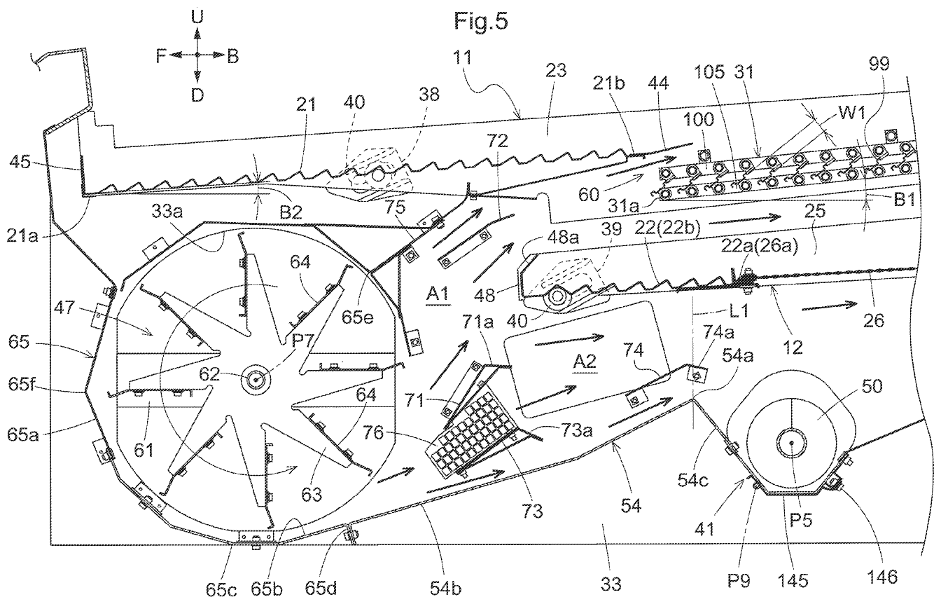

As shown in FIGS. 4 and 5, the first sorting unit 11 for sorting the processed material from the threshing unit 5 is arranged at a position that is below the threshing unit 5 and between the right and left side walls 33, is supported so as to be reciprocally movable along the front-rear direction, and is driven to reciprocate (see the later section “Configuration for reciprocating driving of first sorting unit and second sorting unit”).

The first sorting unit 11 is provided with a frame-shaped first sieve case 23 that is rectangular in a plan view, and, attached to the first sieve case 23 are, in the following stated order, a first grain pan 21 for conveying processed material rearward, a first chaff sieve 31 for sorting and dropping processed material while conveying it rearward, and a straw rack 24 for sorting and dropping processed material while conveying it rearward, and these members extend from the front portion to the rear portion of the first sorting unit 11.

The first grain pan 21 has a saw-tooth shape in a side view, and is provided at a front portion of the first sorting unit 11 (first sieve case 23) in a rearward and upward inclined orientation extending rearward from the front end portion of the first sorting unit 11 (first sieve case 23).

A large number of elongated round bar-shaped sieving lines 44 are coupled to a rear end portion 21b of the first grain pan 21 at intervals along the left-right direction, and the sieving lines 44 extend rearward in a cantilevered manner from the rear end portion 21b of the first grain pan 21. A wall portion 45 formed higher than the first grain pan 21 is provided at a front end portion 21a of the first grain pan 21.

A front end portion 31a of the first chaff sieve 31 is located below the sieving lines 44, and the front end portion 31a of the first chaff sieve 31 and the sieving lines 44 are overlapped with each other in a plan view. The first chaff sieve 31 is provided in the first sorting unit 11 (first sieve case 23) so as to extend rearward in a rearward and upward inclined orientation from the rear end portion 21b of the first grain pan 21 while being separated therefrom by a gap 60 on the rearward side and the lower side.

A support frame 46 is coupled to the first sieve case 23 along the left-right direction in the vicinity of the rear end portion of the first chaff sieve 31. The straw rack 24 has a saw-tooth shape in a side view, and a large number of straw racks 24 are coupled to the support frame 46 at intervals along the left-right direction, and extend rearward in a cantilevered manner from the support frame 46.

Configuration of First Chaff Sieve

As shown in FIGS. 5, 8, and 9, in the first sorting unit 11, a large number of chaff lips 99 that extend along the left-right direction are arranged side by side along the front-rear direction in the first sieve case 23, thus constituting the first chaff sieve 31.

The flat plate-shaped elongated right and left support members 100 are supported along the front-rear direction on the right and left inner surfaces of the first sieve case 23, and upper portions of the right and left end portions of the chaff lips 99 are supported by the support member 100 so as to be swingable around an axis along the left-right direction.

Flat plate-shaped elongated right and left operating members 105 extend along the front-rear direction on the right and left inner surfaces of the first sieve case 23, and lower portions of the right and left end portions of the chaff lips 99 are connected to the operating member 105 so as to be swingable around an axis along the left-right direction.

The chaff lips 99 are inclined rearward and upward in a side view, and when the positions of the operating members 105 are changed in the front-rear direction, the inclination angle of the chaff lips 99 is changed in conjunction with the operating members 105.

When the positions of the operating members 105 are changed to the rear side, the inclination angle of the chaff lips 99 increases, the chaff lips 99 approach an upright posture, and the size of a gap W1 between adjacent chaff lips 99 increases. When the positions of the operating members 105 are changed to the front side, the inclination angle of the chaff lips 99 decreases, the chaff lips 99 approach a horizontal posture, and the size of the gap W1 between adjacent chaff lips 99 decreases.

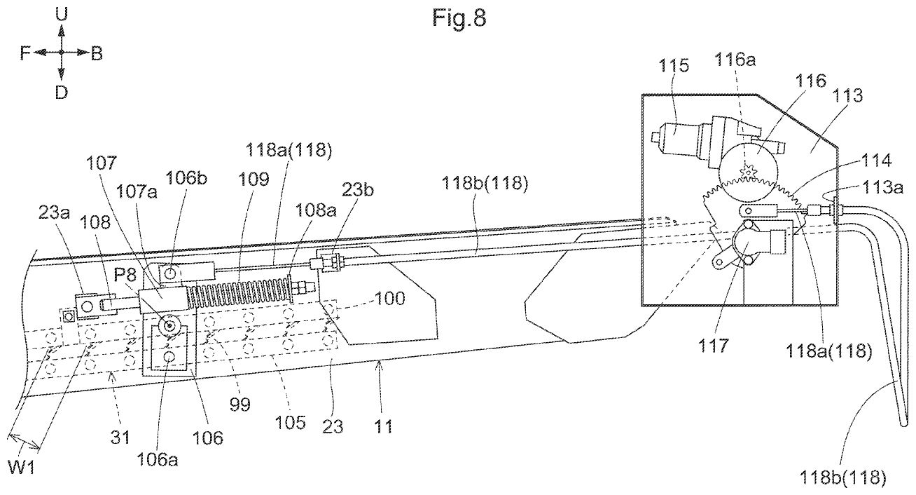

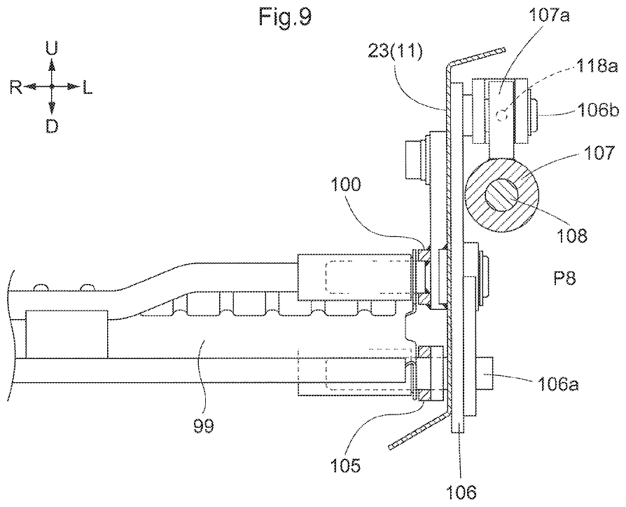

As shown in FIGS. 8 and 9, a plate-like gap changing portion 106 is supported on an outer surface portion of the left portion of the first sieve case 23 so as to be swingable around a swing axis P8 that extends along the left-right direction. An operation pin 106a coupled to a lower portion of the gap changing portion 106 is connected to the left operating member 105 through an opening (not shown) in a left portion of the first sieve case 23.

When the gap changing portion 106 is swung around the swing axis P8, the position of the left operating member 105 is changed in the front-rear direction by the operation pin 106a of the gap changing portion 106, and the position of the right operating member 105 is changed in the front-rear direction via the chaff lip 99.

The gap changing portion 106 is used to operate the first chaff sieve 31 (chaff lips 99) toward an open state such that the size of the gap W1 between adjacent chaff lips 99 increases, or toward a closed state such that the size of the gap W1 decreases.

Configuration for Operating Gap Changing Portion

As shown in FIGS. 8 and 9, a pin-shaped connecting portion 106b is coupled to an upper portion of the gap changing portion 106. A bracket 107a is coupled to a boss portion 107 and is swingably connected to the connecting portion 106b of the gap changing portion 106.

A rod portion 108 that is swingable in the up-down direction is connected to a bracket 23a that is coupled to an outer surface portion of a left portion of the first sieve case 23, and the rod portion 108 is inserted into the boss portion 107 and extends rearward. As a result, the rod portion 108 is connected to the first sorting unit 11 and slidably passes through the boss portion 107.

The rod portion 108 is inserted into a coil spring 109, and the coil spring 109 is provided between the boss portion 107 and a spring receiving portion 108a of the rod portion 108 in a compressed state relative to the free length.

The coil spring 109 operates the gap changing portion 106 in the counterclockwise direction shown in FIG. 8 via the boss portion 107 by extending from the compressed state relative to the free length, and the gap changing portion 106 is biased by the coil spring 109 toward opening via the boss portion 107.

A support plate 113 is coupled to the outer surface portion of the left side wall 33. An operation gear 114 is supported by the support plate 113 so as to be swingable around an axis along the left-right direction, and an electric motor 115, which is an actuator, and a gear mechanism 116 are coupled to the support plate 113. A pinion gear 16a of the gear mechanism 116 is rotationally driven by motive power from the electric motor 115, and the operation gear 114 is swung by the pinion gear 16a of the gear mechanism 116.

One end portion of an outer portion 118b of a wire 118 is connected to a bracket 113a coupled to the support plate 113, and one end portion of an inner portion 118a of the wire 118 is connected to the operation gear 114.

The wire 118 extends rearward from the support plate 113, turns forward, and further extends forward through the space between the left side wall 33 and the left portion of the second sieve case 25. The other end portion of the outer portion 118b of the wire 118 is connected to the bracket 23b that is coupled to the outer surface portion of a left portion of the first sieve case 23, and the other end portion of the inner portion 118a of the wire 118 is connected to the connecting portion 106b of the gap changing portion 106.

Accordingly, the wire 118 is connected to and extends between the electric motor 115 and the gap changing portion 106. The coil spring 109 and the wire 118 (inner portion 118a) are connected to the same upper portion of the gap changing portion 106 that extends from the swing axis P8, and are arranged side by side with each other. The coil spring 109 and the wire 118 (inner portion 118a) are connected to a shared connecting portion 116b provided in the gap changing portion 106.

Operation States of Gap Changing Portion

As shown in FIG. 8, when the operation gear 114 is swung by the electric motor 115 and the inner portion 118a of the wire 118 is pulled toward the electric motor 115, the gap changing portion 106 is swung in the clockwise direction shown in FIG. 8 around the swing axis P8 in resistance against the coil spring 109, and the gap changing portion 106 is operated toward the closed state. Accordingly, the coil spring 109 is compressed by the boss portion 107 and the spring receiving portion 108a of the rod portion 108.

When the operation gear 114 is swung by the electric motor 115 and the inner portion 118a of the wire 118 is returned toward the gap changing portion 106, the coil spring 109 extends and pushes the gap changing portion 106 via the boss portion 107, and thus the gap changing portion 106 is swung in the counter-clockwise direction shown in FIG. 8 around the swing axis P8, and the gap changing portion 106 is operated toward the open state.

A potentiometer-type position sensor 117 is connected to the operation gear 114, and the operating angle of the operation gear 114 is detected by the position sensor 117. Due to the operating angle of the operation gear 114 being detected, the operating position of the gap changing portion 106 is detected, and the size of the gap W1 is detected.

Configuration of Second Sorting Unit

As shown in FIGS. 4, 5, and 6, the second sorting unit 12 for sorting the processed material from the first sorting unit 11 is arranged at a position that is below the first sorting unit 11 and between the right and left side walls 33, is supported so as to be reciprocally movable along the front-rear direction, and is driven to reciprocate (see the later section “Configuration for reciprocating driving of first sorting unit and second sorting unit”).

The second sorting unit 12 is provided with a frame-shaped second sieve case 25 that is rectangular in a plan view, and, attached to the second sieve case 25 are, in the following stated order, a second grain pan 22 for conveying processed material rearward, a grain sieve 26 for dropping the sorted processed material into the primary material collecting unit 41, and a second chaff sieve 32 for conveying processed material rearward and sorting and dropping it into the secondary material collecting unit 42, and these members extend from the front portion to the rear portion of the second sorting unit 12.

The second grain pan 22 has a saw-tooth shape in a side view, and is provided at a front portion of the second sorting unit 12 (second sieve case 25) and extends rearward from the front end portion of the second sorting unit 12 (second sieve case 25). A wall portion 48 formed higher than the second grain pan 22 is provided at a front end portion of the second grain pan 22, and an upper portion 48a of the wall portion 48 faces rearward and diagonally upward.

As will be described later in the section “Configuration of first air passage and first, second, and fifth wind direction members”, a portion of the sorting wind from the grain fan 47 flows rearward between the first sorting unit 11 (rear portion of the first grain pan 21) and the wall portion 48, and thus the wall portion 48 prevents processed material from spilling from the second grain pan 22 to the front side.

The grain sieve 26 is constituted by a punching metal member that is a flat plate-shaped member in which a large number of small openings are formed, and a crimp net formed by woven thin metal wires. The grain sieve 26 is connected to a rear end portion 22a of the second grain pan 22, and is provided in the second sorting unit 12 (second sieve case 25) so as to extend rearward from the rear end portion 22a of the second grain pan 22.

A large number of elongated round bar-shaped sieving lines 49 that are saw-tooth shaped in a side view are coupled to a rear end portion 26b of the grain sieve 26 at intervals along the left-right direction, and the sieving lines 49 extend rearward in a cantilevered manner from the rear end portion 26b of the grain sieve 26.

A front end portion 32a of the second chaff sieve 32 is located slightly rearward away from the rear end portion 26b of the grain sieve 26, and the second chaff sieve 32 is provided in the second sorting unit 12 (second sieve case 25) so as to extend rearward in a rearward and upward inclined state.

Similarly to the first chaff sieve 31 described in the previous section “Configuration of first chaff sieve”, in the second chaff sieve 32, a large number of chaff lips 110 that extend along the left-right direction are arranged side by side along the front-rear direction in the second sieve case 25, thus constituting the second chaff sieve 32.

Similarly to the first chaff sieve 31, the size of the gaps between the chaff lips 110 of the second chaff sieve 32 can be changed by changing the inclination angle of the chaff lips 110 of the second chaff sieve 32. In this case, the worker manually changes the inclination angle (gaps) of the chaff lip 110 by using a tool or the like.

Configuration of Rear End Portion and Rear Wall Portion of Second Sieve Case

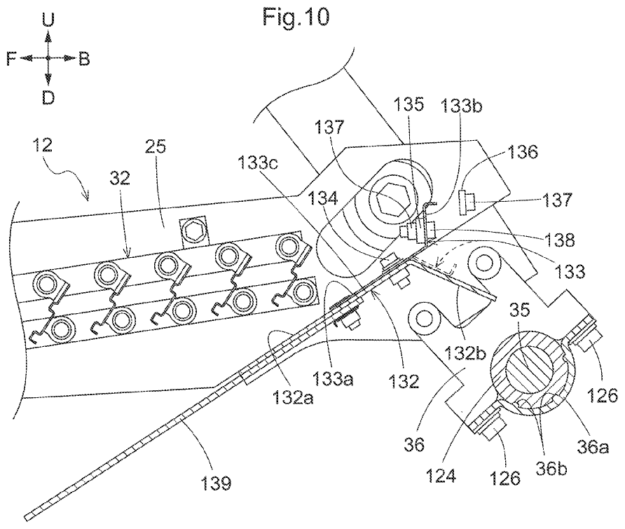

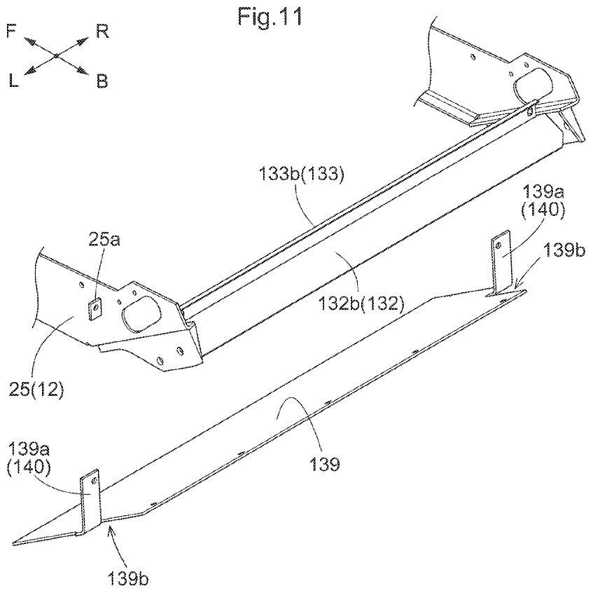

As shown in FIGS. 10 and 11, a rear end portion 132 coupled to the second sieve case 25 has a flat plate shape along the left-right direction, a front portion 132a of the rear end portion 132 is inclined rearward and upward in a side view, and a rear portion 132b of the rear end portion 132 is inclined rearward and downward in a side view.

The front portion 132a of the rear end portion 132 is provided with a rear wall portion 133 that extends between the left and right ends of the second sorting unit 12. The rear wall portion 133 is formed by a bent plate member, the rear wall portion 133 includes a lower portion 133a that extends along the front portion 132a of the rear end portion 132, and an upper portion 133b that extends upward from the lower portion 133a, and an elongated hole 133c that extends in the front-rear direction is formed in the lower portion 133a.

The lower portion 133a of the rear wall portion 133 is slidable along the front portion 132a of the rear end portion 132, and the rear wall portion 133 extends in a rearward and upward inclined direction in a side view and is supported by the rear end portion 132 such that the position can be changed in the front-rear direction and the up-down direction.

When the position of the rear wall portion 133 is moved forward relative to the rear end portion 132, the upper portion 133b of the rear wall portion 133 moves forward and downward. When the position of the rear wall portion 133 is moved rearward relative to the rear end portion 132, the upper portion 133b of the rear wall portion 133 moves rearward and upward.

A bolt 134, which is a position fixing portion, is tightly screwed into a coupling hole in the front portion 132a of the rear end portion 132 and the elongated hole 133c of the rear wall portion 133, and thus the rear wall portion 133 (lower portion 133a) is fixed to the rear end portion 132. By loosening the bolt 134, the rear wall portion 133 (lower portion 133a) is released from being fixed, and the rear wall portion 133 can be moved forward or rearward relative to the rear end portion 132 as described above.

Configuration of Guideline Portion of Second Sieve Case

As shown in FIG. 10, two guideline portions 135 and 136, which indicate positions where the rear wall portion 133 is to be fixed, are coupled to inner surface portions of a right portion and a left portion of a rear portion of the second sieve case 25 with a gap therebetween in the front-rear direction. A nut 137 is coupled to a front surface portion of the guideline portion 135, and a nut 137 is coupled to a rear surface portion of the guideline portion 136.

The right portion of the upper portion 133b of the rear wall portion 133 is arranged between the guideline portions 135 and 136 of the rear right portion of the second sieve case 25, and the left portion of the upper portion 133b of the rear wall portion 133 is arranged between the guideline portions 135 and 136 on the left side of the rear portion of the second sieve case 25.

When the rear wall portion 133 is moved forward or rearward relative to the rear end portion 132, the position where the upper portion 133b of the rear wall portion 133 comes into contact with the guideline portion 135 is the frontmost position of the rear wall portion 133, and the position where the upper portion 133b of the wall portion 133 comes into contact with the guideline portion 136 is the rearmost position of the rear wall portion 133.

The state shown in FIG. 10 is a state in which the rear wall portion 133 is located at the frontmost position, and a bolt 138, which is a connector, is tightly screwed into the upper portion 133b of the rear wall portion 133 and the nut 137 of the guideline portion 135, and the upper portion 133b of the rear wall portion 133 is coupled to the guideline portion 135. Accordingly, the position of the rear wall portion 133 is fixed to the second sieve case 25 by the bolt 134 and the bolt 138.

When the bolt 138 is removed from the state shown in FIG. 10 and the rear wall portion 133 is uncoupled, the position of the rear wall portion 133 can be moved rearward. When the rear wall portion 133 is at the rearmost position, if the bolt 138 is tightly screwed into the upper portion 133b of the rear wall portion 133 and the nut 137 of the guideline portion 136, the upper portion 133b of the rear wall portion 133 becomes coupled to the guideline portion 136.

When the upper portion 133b of the rear wall portion 133 is located between the guideline portions 135 and 136, if the position of the rear wall portion 133 is fixed by the bolt 134, the upper portion 133b of the rear wall portion 133 is not coupled to the guideline portions 135 and 136, and thus the bolt 138 is attached to the nut 137 of the guideline portion 135 or the nut 137 of the guideline portion 136.

When the bolts 134 and 138 are removed, the rear wall portion 133 can be pulled out rearward from the rear end portion 132. Thereafter, the rear wall portion 133 is vertically inverted, and as shown by the dashed line in FIG. 10, the lower portion 133a of the rear wall portion 133 can be placed on the front portion 132a of the rear end portion 132, and the upper portion 133b of the rear wall portion 133 can be placed on the rear portion 132b of the rear end portion 132. This state is close to a state in which the rear wall portion 133 does not exist.

In this state, by tightly screwing the bolt 134 to the coupling hole of the front portion 132a of the rear end portion 132 and the elongated hole 133c of the rear wall portion 133, the rear wall portion 133 becomes fixed to the rear end portion 132. The bolt 138 is attached to the nut 137 of the guideline portion 135 or the nut 137 of the guideline portion 136.

Configuration of Guide Member

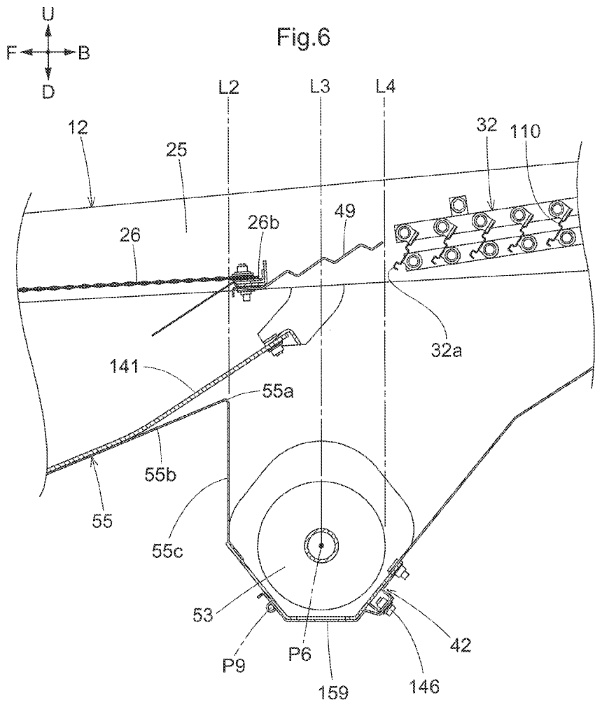

As shown in FIGS. 4 and 6, in the second sorting unit 12, a flat plate-shaped guide member 141 made of a flexible rubber plate extends in a forward and downward inclined state from the position of the rear end portion 26b of the grain sieve 26 toward the primary material collecting unit 41 that is arranged below the second sorting unit 12. The grain that is the processed material from the second sorting unit 12 is guided to the primary material collecting unit 41 by the guide member 141.

As shown in FIGS. 4, 10, and 11, a flat plate-shaped guide member 139 made of a flexible rubber plate is coupled to the front portion 132a of the rear end portion 132 of the second sieve case 25 and extends in a forward and downward inclined state toward the secondary material collecting unit 42 that is arranged below the second sorting unit 12. A mixture of grain and straw waste or the like, which is the processed material from the second sorting unit 12, is guided to the secondary material collecting unit 42 by the guide member 139.

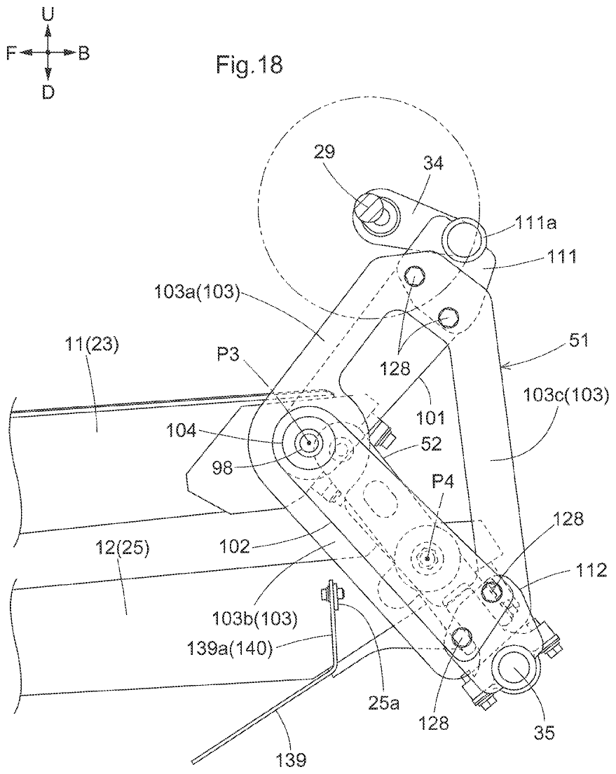

As shown in FIGS. 11 and 18, right and left slits 139b that extend forward from the rear end portion of the guide member 139 are formed in a right portion and a left portion of a rear end portion of the guide member 139. An outer portion 139a rightward of the right slit 139b in the guide member 139 is bent upward to extend between the right portion of the second sieve case 25 and the right side wall 33, and the right portion 139a of the guide member 139 is bolted to the right bracket 25a that is coupled to the second sieve case 25.

An outer portion 139a leftward of the left slit 139b in the guide member 139 is bent upward to extend between the left portion of the second sieve case 25 and the left side wall 33, and the left portion 139a of the guide member 139 is bolted to the left bracket 25a that is coupled to the second sieve case 25.

Right and left leak prevention portions 140 are formed by the right and left portions 139a of the guide member 139, and the leak prevention portion 140 are arranged at positions above the guide member 139 between the second sieve case 25 and the side wall 33.

Accordingly, in the vicinity of the rear portion of the second sieve case 25, the gaps between the second sieve case 25 and the side wall 33 are closed by the leak prevention portions 140, thus suppressing the case where processed material leaks rearward through the gaps between the second sieve case 25 and the side wall 33.

Configuration of Inspection Openings in Right and Left Side Walls

As shown in FIG. 2, the left side wall 33 is provided with inspection openings 33b, 33c, 33d, and 33e and inspection covers 142, 143, and 144.

Removing the inspection cover 142 opens the inspection opening 33b of the upper side wall 33 above the grain sieve 26 in a side view and the inspection opening 33c of the side wall 33 that is below the grain sieve 26 in a side view. When the inspection opening 33b of the side wall 33 is opened, the upper portion of the grain sieve 26 can be inspected and cleaned.

When the inspection opening 33c of the side wall 33 is opened, the lower side of the grain sieve 26 is exposed, and thus when the removed second sorting unit 12 is inserted from the rear side of the combine, the worker can perform operations such that the guide members 139 and 141 (see the previous section “Configuration of guide member”) are appropriately arranged relative to the primary material collecting unit 41 and the secondary material collecting unit 42.

When the inspection cover 143 is removed and the inspection opening 33d of the side wall 33 is exposed, the region including the gap changing portion 106 (see the previous section “Configuration for operating the gap changing portion”) is exposed. The worker can adjust the wire 118, the coil spring 109, and the like.

When the inspection cover 144 is removed and the inspection opening 33e of the side wall 33 is exposed, the region including the second chaff sieve 32 is exposed. The worker can change the inclination angle of the chaff lips 110 of the second chaff sieve 32 (see the previous section “Configuration of second sorting unit”).

As shown in FIG. 3, the right side wall 33 is provided with inspection openings 33f and 33g and inspection covers 157 and 158.

When the inspection cover 157 is removed and the inspection opening 33f of the side wall 33 is exposed, the upper portion of the grain sieve 26 can be inspected and cleaned.

When the inspection cover 158 is removed, the inspection opening 33g of the side wall 33 is opened, and thus when the removed first sorting unit 11 is inserted from the rear side of the combine, the worker can perform operations such that a flexible guide member (not shown) at the front end portion of the threshing unit 5 can be appropriately arranged on the first sorting unit 11.

Configuration of Primary Material Collecting Unit, Secondary Material Collecting Unit, and Inspection Openings of Conveying Apparatus

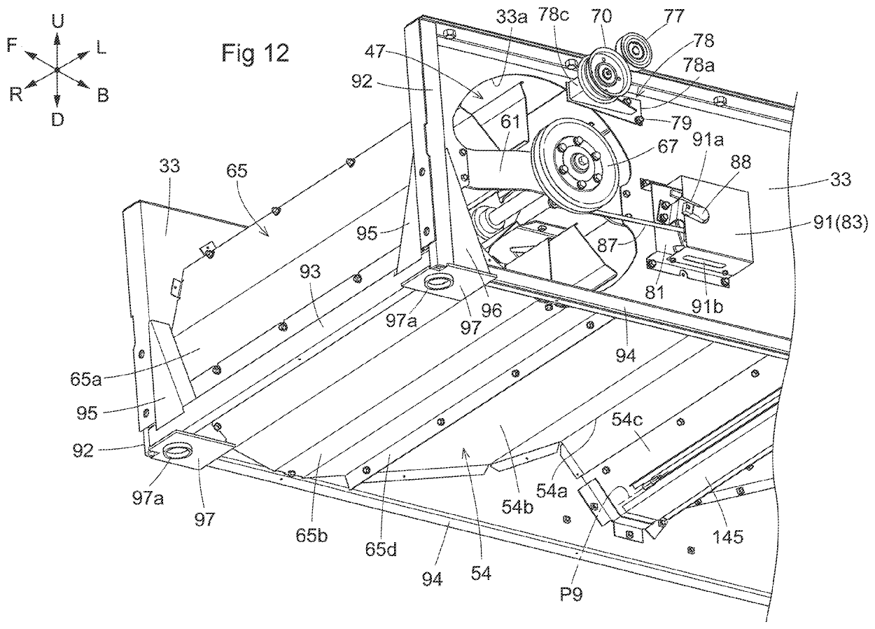

As shown in FIGS. 5 and 12, a front end portion of a bottom plate portion 145 of the primary material collecting unit 41 is supported so as to be swingably openable and closable around an axis P9 that extends along the left-right direction, and a coupling bolt 146 for fixing the bottom plate portion 145 in the closed state is provided at a rear end portion of the bottom plate portion 145.

By removing the coupling bolt 146 and opening the bottom plate portion 145 downward, the primary material collecting unit 41 can be inspected and cleaned. As shown in FIG. 6, a bottom plate portion 159 of the secondary material collecting unit 42 is configured similarly to the bottom plate portion 145 of the primary material collecting unit 41.

As shown in FIG. 3, the conveying apparatus 66 that supplies the grain collected by the primary material collecting unit 41 to the grain tank 6 is provided with inspection openings 66a, 66b, 66c, and 66d that are located in a lower portion, an upper portion, and an intermediate portion of the conveying apparatus 66.

A swingable open/close type of inspection cover 148 covers the inspection opening 66a of the conveying apparatus 66, a removable open/close type of inspection cover 149 covers the inspection opening 66b of the conveying apparatus 66, a removable open/close type of inspection cover 151 covers the inspection opening 66c of the conveying apparatus 66, and a removable open/close type of inspection cover 152 covers the inspection opening 66d of the conveying apparatus 66.

The conveying apparatus 147 that supplies a mixture of grain, straw waste, and the like collected by the secondary material collecting unit 42 to a front portion of the first sorting unit 11 is provided with inspection openings 147a, 147b, 147c, and 147d that are located in a lower portion, an upper portion, and an intermediate portion of the conveying apparatus 147.

A swingable open/close type of inspection cover 153 covers the inspection opening 147a of the conveying apparatus 147, a removable open/close type of inspection cover 154 covers the inspection opening 147b of the conveying apparatus 147, a swingable open/close type of inspection cover 155 covers the inspection opening 147c of the conveying apparatus 147, and a swingable open/close type of inspection cover 156 covers the inspection opening 147d of the conveying apparatus 147.

Configuration of Grain Fan

As shown in FIGS. 4 and 5, the front portion of the first sorting unit 11 extends forward such that the front portion of the first sorting unit 11 is located in front of the front portion of the second sorting unit 12. The grain fan 47 is provided below the front portion of the threshing unit 5, and is arranged at a location that is below the front portion of the first sorting unit 11 and forward of the front portion of the second sorting unit 12.

As shown in FIGS. 2 and 3, a circular opening 33a is formed in a front portion of each of the right and left side walls 33, and flat right and left support frames 61 are coupled to and extend between a front portion and a rear portion of the openings 33a of the side walls 33.

As shown in FIGS. 5, 7, and 14, a drive shaft 62 is rotatably supported by and extends between the right and left support frames 61, and right and left support plates 63 that are star-shaped in a side view are coupled to the drive shaft 62. A blade plate 64 is coupled to each arm portion of the right and left support plates 63, and the blade plates 64 have a flat plate shape and are slightly bent in a side view. The grain fan 47 is rotationally driven around an axis P7 that extends along the left-right direction of the drive shaft 62 in the counterclockwise direction show in FIG. 5.

As shown in FIGS. 5 and 12, a grain fan case 65 is provided above, in front of, and below the grain fan 47, the outward side of the grain fan 47 is covered by the grain fan case 65, and the grain fan case 65 is provided with a front case portion 65a and a rear case portion 65b.

A right end portion of the front case portion 65a of the grain fan case 65 is coupled to an inner surface portion of the right side wall 33, and a left end portion of the front case portion 65a of the grain fan case 65 is coupled to an inner surface portion of the left side wall 33. A front end portion 14a of the receiving net 14 and a front end portion 65f of the grain fan case 65 (front case portion 65a) are arranged at the same position in the front-rear direction. A plurality of small openings 65c for draining water are formed in a bottom portion of the rear case portion 65b of the grain fan case 65.

As shown in FIG. 1, a synthetic resin cover 69 is provided on the outside of the left side wall 33. A large number of small openings 69a are formed in a portion of the cover 69 that faces the opening 33a of the left side wall 33.

According to the above configuration, when the grain fan 47 is driven to rotate, air is introduced into the grain fan 47 through the openings 33a of the side walls 33, sorting wind from the grain fan 47 moves diagonally upward and rearward from the vicinity of the lower portion of the grain fan 47, and passes between the right and left side walls 33 and is supplied to the first sorting unit 11 and the second sorting unit 12 as described in the later sections “Configuration of first air passage and first, second, and fifth wind direction members” and “Configuration of second air passage and third, fourth, and sixth wind direction members”.

Configurations of Primary Material Collecting Unit, Secondary Material Collecting Unit, Front Partition Unit, and Rear Partition Unit

As shown in FIGS. 4 and 5, a conveying screw 50 is provided in the primary material collecting unit 41 so as to be rotatable around a screw axis P5 that extends along the left-right direction. A conveying screw 53 is provided in the secondary material collecting unit 42 so as to be rotatable around a screw axis P6 that extends along the left-right direction.

As shown in FIGS. 4, 5, and 12, a mountain-shaped front partition unit 54 that projects upward in a side view is provided between the primary material collecting unit 41 and the grain fan 47. The front partition unit 54 includes a bottom portion 54b that extends diagonally forward and downward from a peak portion 54a, and an inclined portion 54c that extends diagonally rearward and downward from the peak portion 54a.

The inclined portion 54c of the front partition unit 54 is connected to a lower portion of the primary material collecting unit 41, and the primary material collecting unit 41 is provided at a location that is below the second sorting unit 12 and rearward of the peak portion 54a, which is the rear end portion of the bottom portion 54b of the front partition unit 54.

The bottom portion 54b of the front partition unit 54 is coupled to the lower end portion 65d of the grain fan case 65 (rear end portion of the case portion 65b), and the bottom portion 54b of the front partition unit 54 extends rearward from the lower end portion 65d of the grain fan case 65 (rear end portion of the case portion 65b).

The front end portion of the rear case portion 65b of the grain fan case 65 is placed on the front side of a lower end portion of the front case portion 65a of the grain fan case 65 and bolted thereto. A front end portion of the bottom portion 54b of the front partition unit 54 and the lower end portion 65d of the rear case portion 65b of the grain fan case 65 are bent downward and abutted against each other, and are bolted together along the front-rear direction. By removing the bolts, the rear case portion 65b of the grain fan case 65 can be replaced with another case portion 65b.

As shown in FIGS. 4 and 6, a mountain-shaped rear partition unit 55 that projects upward in a side view is provided between the primary material collecting unit 41 and the secondary material collecting unit 42. The rear partition unit 55 includes a bottom portion 55b that extends diagonally forward and downward from a peak portion 55a, and a vertical wall portion 55c that extends downward from the peak portion 55a. The bottom portion 55b of the rear partition unit 55 is connected to a lower portion of the primary material collecting unit 41, and the vertical wall portion 55c of the rear partition unit 55 is connected to a front portion and a lower portion of the secondary material collecting unit 42.

Configurations of First Air Passage and First, Second, and Fifth Wind Direction Members

As shown in FIGS. 4, 5, and 7, a flat plate-shaped first wind direction member 71, which is an upward wind direction member, is provided at a position that is rearward of the grain fan 47 and at the same height as the drive shaft 62. The first wind direction member 71 extends between the right and left side walls 33, is inclined rearward and upward such that the front portion of the first wind direction member 71 is lower than the rear portion, and a rear end portion 71a of the first wind direction member 71 extends approximately horizontally.

A fifth wind direction member 75 extends diagonally upward and rearward from the upper end portion 65e of the grain fan case 65. A first air passage A1 is formed between the first wind direction member 71 and the fifth wind direction member 75, and a second air passage A2 is formed between the first wind direction member 71 and the bottom portion 54b of the front partition unit 54.

Sorting wind from the grain fan 47 is branched by the first wind direction member 71 is guided to the first air passage A1, and is guided by the first air passage A1 so as to pass between the first sorting unit 11 and the second sorting unit 12.

Sorting wind from the grain fan 47 is branched by the first wind direction member 71, is guided to the second air passage A2, and, as described later in the section “Configuration of second air passage and third, fourth, and sixth wind direction members”, is guided by the second air passage A2 from below the second sorting unit 12 to the second sorting unit 12.

A flat plate-shaped second wind direction member 72 is arranged at a position that is below a front portion of the first sorting unit 11 and forward of a front portion of the second sorting unit 12, and is arranged between a fifth wind direction member 75 and the wall portion 48 of the second sorting unit 12. The second wind direction member 72 extends between the right and left side walls 33, and is inclined rearward and upward such that the front portion of the second wind direction member 72 is lower than the rear portion.

Out of the sorting wind in the first air passage A1, the sorting wind in the first air passage A1 that passes above the second wind direction member 72 flows along the bottom portion of the first grain pan 21 and is guided to the gap 60.

The sorting wind in the first air passage A1 that passes below the second wind direction member 72 passes between the second wind direction member 72 and the wall portion 48 provided at the front end portion of the second sorting unit 12, and is guided between the first sorting unit 11 and the second sorting unit 12.

Configurations of Second Air Passage and Third, Fourth, and Sixth Wind Direction Members

As shown in FIGS. 4, 5, and 7, a flat plate-shaped third wind direction member 73, which is a lower wind direction member, is provided at a location that is rearward of the grain fan 47 and below the first wind direction member 71, and extends between the right and left side walls 33.

The third wind direction member 73 is in a rearward and upward inclined state in which the front portion of the third wind direction member 73 is lower than the rear portion, and extends along the bottom portion 54b of the front partition unit 54, and a rear end portion 73a of the third wind direction member 73 extends downward.

A flat plate-shaped fourth wind direction member 74 is provided at a position spaced rearward from the rear end portion 73a of the third wind direction member 73, and extends between the right and left side walls 33. The fourth wind direction member 74 is in a rearward and upward inclined state in which the front portion of the fourth wind direction member 74 is lower than the rear portion, and extends along the bottom portion 54b of the front partition unit 54. A rear end portion 74a of the fourth wind direction member 74 extends downward and is located above the peak portion 54a of the front partition unit 54.

Right and left sixth wind direction members 76 are arranged between the first wind direction member 71 and the third wind direction member 73. The sixth wind direction member 76 has a flat plate shape and is provided with a large number of openings, is in an inclined state in which the rear portion of the sixth wind direction member 76 is closer to the lateral center portion between the right and left side walls 33 than the front portion is, and is coupled to the first wind direction member 71 and the third wind direction member 73.

Sorting wind from the grain fan 47 is branched by the first wind direction member 71 and guided to the second air passage A2, sorting wind in the second air passage A2 passes between the first wind direction member 71 and the third wind direction member 73, flows along the bottom portion of the second grain pan 22, and is guided to the bottom portion of the grain sieve 26, and is then guided from below the second sorting unit 12 to the second sorting unit 12.

When the sorting wind in the second air passage A2 passes between the first wind direction member 71 and the third wind direction member 73, the sorting wind in the second air passage A2 (grain fan 47) flowing along the right side wall 33 is guided toward the lateral center portion between the right and left side walls 33 by the right sixth wind direction member 76, and the sorting wind in the second air passage A2 (grain fan 47) that has passed through the openings in the right sixth wind direction member 76 flows along the right side wall 33.

When the sorting wind in the second air passage A2 passes between the first wind direction member 71 and the third wind direction member 73, the sorting wind in the second air passage A2 (grain fan 47) flowing along the left side wall 33 is guided toward the lateral center portion between the right and left side walls 33 by the left sixth wind direction member 76, and the sorting wind in the second air passage A2 (grain fan 47) that has passed through the openings in the left sixth wind direction member 76 flows along the left side wall 33.

A portion of the sorting wind in the second air passage A2 is branched by the third wind direction member 73, and the sorting wind branched from the second air passage A2 is guided by the third wind direction member 73 so as to flow along the bottom portion 54b of the front partition unit 54, and is guided by the fourth wind direction member 74 so as to flow along the bottom portion 54b of the front partition unit 54.

Accordingly, the sorting wind flowing along the bottom portion 54b of the front partition unit 54 (the sorting wind branched from the second air passage A2) passes between the third wind direction member 73 and the bottom portion 54b of the front partition unit 54, and between the fourth wind direction member 74 and the bottom portion 54b of the front partition unit 54, and is guided to an upper portion of the primary material collecting unit 41.

When the sorting wind flowing along the bottom portion 54b of the front partition unit 54 (the sorting wind branched from the second air passage A2) flows from a position between the third wind direction member 73 and the bottom portion 54b of the front partition unit 54 to a position between the fourth wind direction member 74 and the bottom portion 54b of the front partition unit 54, it can be expected that air from a position between the third wind direction member 73 and the fourth wind direction member 74 will merge with the sorting wind flowing along the bottom portion 54b of the front partition unit 54 (the sorting wind branched from the second air passage A2).

Configuration of Rotational Driving of Conveying Screws of Primary Material Collecting Unit and Secondary Material Collecting Unit

As shown in FIGS. 2 and 15, the transmission shaft 27 is rotatably supported by a rear portion of the left side wall 33, and a transmission belt 28 is wound around a pulley 17b coupled to a left portion of the transmission shaft 17 and a pulley 27a coupled to the transmission shaft 27.

A relay shaft 56 is rotatably supported by the left side wall 33, and a transmission belt 57 is wound around a pulley 56a coupled to the relay shaft 56 and a pulley 27c coupled to the transmission shaft 27.

A pulley 50a is coupled to a right end portion of the conveying screw 50, and a pulley 53a is coupled to a right end portion of the conveying screw 53. A transmission belt 58 is wound around a pulley (not shown) coupled to the relay shaft 56, the pulley 50a of the conveying screw 50, and the pulley 53a of the conveying screw 53. A transmission belt 59 is wound around a pulley (not shown) coupled to the relay shaft 56 and a pulley 9a provided on a left portion of the feeder 9.

As described above in the section “Configuration of threshing unit”, motive power transmitted to the transmission shaft 17 is transmitted to the relay shaft 56 via the transmission shaft 27 and the transmission belts 28 and 57, and is transmitted to the conveying screws 50 and 53 via the transmission belt 58, and thus the conveying screws 50 and 53 are driven to rotate. The motive power transmitted to the relay shaft 56 is transmitted to the pulley 9a of the feeder 9 via the transmission belt 59, and is transmitted from the feeder 9 to the reaping unit 10.

According to the above configuration, when grain that is the sorted processed material falls from the second sorting unit 12 to the primary material collecting unit 41, the grain is collected by the rotating conveying screw 50 and conveyed to the right side wall 33, and is then supplied from an outlet in the right side wall 33 to the grain tank 6 by the conveying apparatus 66 (see FIG. 3).

When a mixture of grain, straw waste, and the like, which is the sorted processed material, falls from the second sorting unit 12 to the secondary material collecting unit 42, the mixture is collected by the rotating conveying screw 53 and conveyed to the right side wall 33, and is then supplied from an outlet in the right side wall 33 to a front portion of the first sorting unit 11 by the conveying apparatus 147 (see FIG. 3).

Configuration of Rotational Driving of Grain Fan

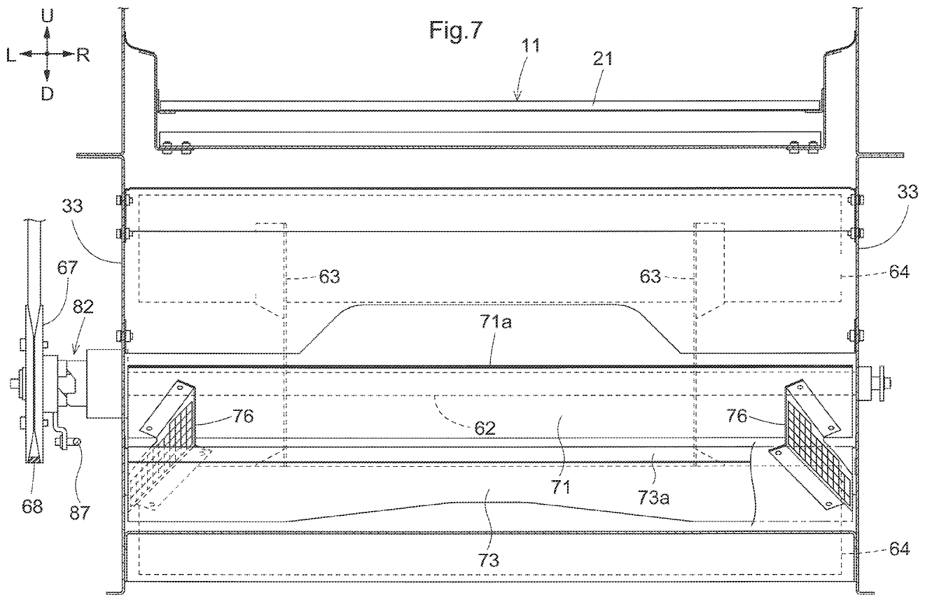

As shown in FIGS. 2 and 7, in the grain fan 47, a divided pulley type of variable pulley 67 is attached to a left end portion of the drive shaft 62, and a transmission belt 68 is wound around a pulley (not shown) coupled to the relay shaft 56 and the variable pulley 67. Motive power transmitted to the relay shaft 56 is transmitted to the variable pulley 67 via the transmission belt 68, and thus the grain fan 47 is driven to rotate in the counterclockwise direction shown in FIG. 2.

The rotation speed of the grain fan 47 can be changed by changing the distance between the opposing pulley portions of the variable pulley 67 so as to change the radius of contact between the transmission belt 68 and the variable pulley 67.

When the distance between the pulley portions of the variable pulley 67 is reduced, the radius of contact between the transmission belt 68 and the variable pulley 67 increases, the grain fan 47 is driven to rotate at a lower speed, and the air volume produced by the grain fan 47 decreases. This state is suitable for when the amount of processed material is small.

When the distance between the pulley portions of the variable pulley 67 is increased, the radius of contact between the transmission belt 68 and the variable pulley 67 decreases, the grain fan 47 is driven to rotate at a higher speed, and the air volume produced by the grain fan 47 increases. This state is suitable for when the amount of processed material is large.

As shown in FIGS. 2, 12, and 13, two tension pulleys 70 and 77 are provided for the transmission belt 68. A support portion 78 supports the tension pulleys 70 and 77, and the support portion 78 is coupled to a portion of the outer surface portion of the left side wall 33 that is adjacent to a rear portion of an upper portion of the opening 33a of the side wall 33.

As described above in the section “Configuration of grain fan”, a right end portion and a left end portion of the grain fan case 65 are coupled to inner surface portions of the right and left side walls 33. The support portion 78 is coupled to a portion of the outer surface portion of the left side wall 33 that faces the inner surface portion of the left side wall 33 to which the left end portion of the grain fan case 65 is coupled.

The support portion 78 includes a flat plate-shaped base plate 78a, a fulcrum shaft 78b coupled to the base plate 78a, an angle-bent reinforcing plate 78c coupled to the base plate 78a and the fulcrum shaft 78b, an arm 78d that is supported so as to be swingable around the fulcrum shaft 78b, and the like.

The base plate 78a of the support portion 78 is coupled to an outer surface portion of the side wall 33 by a plurality of bolts 79, and a tension spring 80 is attached to the arm 78d of the support portion 78. The tension pulley 70 is rotatably supported by the fulcrum shaft 78b of the support portion 78, and the tension pulley 77 is rotatably supported by the arm 78d of the support portion 78.

As described above, if the distance between the pulley portions of the variable pulley 67 is changed and the radius of contact between the transmission belt 68 and the variable pulley 67 is changed, the arm 78d of the support portion 78 and the tension pulley 77 swing in response so as to maintain the tension of the transmission belt 68.

Configuration of Rotation Speed Changing Portion for Changing Rotation Speed of Grain Fan to Change Air Volume of Sorting Wind from Grain Fan

As shown in FIGS. 7, 11, 12, and 13, a reinforcing member 81 formed by bending a plate member into a channel shape is arranged at the same height position as the drive shaft 62 and the support frame 61 at a position rearward of the grain fan 47, and is coupled to an outer surface portion of the left side wall 33.

As described above in the section “Configuration of first air passage and first, second, and fifth wind direction members” and “Configuration of second air passage and third, fourth, and sixth wind direction members”, right and left end portions of the first wind direction member 71 and right and left end portions of the third wind direction member 73 are coupled to inner surface portions of the right and left side walls 33.

In this case, the first wind direction member 71 and the third wind direction member 73 extend between an inner surface portion facing the reinforcing member 81 on the left side wall 33 to which the reinforcing member 81 is coupled, and an inner surface portion facing the reinforcing member 81 on the right side wall 33.

A gap changing mechanism 82 that can change the distance between the pulley portions of the variable pulley 67 is provided at a base portion of the variable pulley 67. The rotation speed changing portion 83 is supported by the reinforcing member 81, and when the gap changing mechanism 82 is operated by the rotation speed changing portion 83, the rotation speed of the grain fan 47 is changed, and the air volume of the sorting wind from the grain fan 47 is changed.

The rotation speed changing portion 83 is provided with an operation gear 84, an electric motor 85, a gear mechanism 86, an operation rod 87, a position sensor 88, and the like. The operation gear 84 is supported by the reinforcing member 81 so as to be swingable around an axis along the left-right direction, and the electric motor 85 and the gear mechanism 86 are coupled to the reinforcing member 81. The operation rod 87 is connected to and extends between a bracket 84a provided on the operation gear 84 and the gap changing mechanism 82.

The pinion gear 86a of the gear mechanism 86 is driven to rotate by motive power from the electric motor 85, the operation gear 84 is swung by the pinion gear 86a of the gear mechanism 86, the operation rod 87 is pushed and pulled, and thus the gap changing mechanism 82 is operated by the operation rod 87. Two stopper portions 81a are coupled to the reinforcing member 81, and the positions where the operation gear 84 is stopped by the stopper portions 81a of the reinforcing member 81 are the operating limits of the gap changing mechanism 82.

An angled support bracket 89 is coupled to the reinforcing member 81, and a potentiometer type of position sensor 88 is supported by the support bracket 89. A detection arm 88a capable of swinging around the same axis as the axis on which the operation gear 84 swings is provided on the position sensor 88, and the detection arm 88a of the position sensor 88 is connected to the bracket 84b of the operation gear 84. When the operation gear 84 is swung, the detection arm 88a of the position sensor 88 swings in conjunction, and the position of the operation gear 84 is detected by the position sensor 88.

A relay switch 90 for operating the electric motor 85 is coupled to an inner surface portion of the reinforcing member 81 and is arranged between an outer surface portion of the left side wall 33 and the reinforcing member 81.

A cover 91 that is bent in a channel shape is coupled to the reinforcing member 81, and the rotation speed changing portion 83 is covered by the cover 91. The front portion of the cover 91 is open, and the operation rod 87 passes through the front portion of the cover 91. The rear portion of the cover 91 is open, and the electric motor 85 and the gear mechanism 86 protrude a small amount from the rear portion of the cover 91.

A cutout portion 91a is provided in the front portion of the cover 91, and the position sensor 88 protrudes from the cutout portion 91a of the cover 91. An opening 91b for discharging small waste matter or the like is formed in a lower portion of the cover 91.

Configuration for Reciprocating Driving of First Sorting Unit and Second Sorting Unit

As shown in FIGS. 15, 17, and 18, a crank shaft 29 serving as a drive unit is supported by and extends between the right and left side walls 33 and can rotate around the axis P2 extending along the left-right direction, and a transmission chain 30 is wound around a sprocket 27b coupled to the transmission shaft 27 and a sprocket 29a coupled to the crank shaft 29.

Right and left fulcrum shafts 98 are coupled to the right and left side walls 33. Right and left drive members 51, which are first drive mechanisms, are supported by the fulcrum shafts 98 so as to be able to reciprocally swing around an axis P3 extending along the left-right direction, and are arranged outward of the right and left side walls 33. An interconnecting link 34 is connected to and extends between a crank portion 29b that is shifted from the axis P2 of the crank shaft 29 and upper portions of the right and left drive members 51.

An interconnecting shaft 35 is coupled to and extends between lower portions of the right and left drive members 51. Right and left connecting members 36 are connected to the interconnecting shaft 35, the right and left connecting members 36 are coupled to a rear portion of the second sorting unit 12 (second sieve case 25), and the drive member 51 is connected to the second sorting unit 12 (second sieve case 25).

Right and left drive arms 52, which are second drive mechanisms, are supported by the right and left side walls 33 so as to be able to reciprocally swing around an arm axis P4 extending along the left-right direction, and are arranged inward of the right and left side walls 33. The drive arms 52 are shaped as a balance and extend to one side and the other side from the arm axis P4.

An interconnecting shaft 37 is rotatably supported by and extends between portions of the right and left drive arm 52 that are on one side of the arm axis P4, a rear portion of the first sorting unit 11 (first sieve case 23) is coupled to the interconnecting shaft 37, and the portions of the drive arms 52 on the one side of the arm axis P4 are connected to the first sorting unit 11 (first sieve case 23).

The portions of the drive arms 52 on the other side of the arm axis P4 are connected to the interconnecting shaft 35, and the portions of the drive arm 52 on the other side of the arm axis P4 are connected to the second sorting unit 12 (second sieve case 25) via the interconnecting shaft 35 and the connecting members 36.

As shown in FIG. 5, guide portions 38 and 39 are coupled to inner surface portions of the right and left side walls 33 and extend along the front-rear direction. A roller 40 is supported by right and left portions of a front portion of the first sorting unit 11 (first sieve case 23), and the roller 40 is supported by the guide portion 38. A roller 43 is supported by right and left portions of a front portion of the second sorting unit 12 (second sieve case 25), and the roller 43 is supported by the guide portion 39.

The front portion of the first sorting unit 11 and the front portion of the second sorting unit 12 are supported by the guide portions 38 and 39 and the rollers 40 and 43 so as to be able to reciprocally move along the front-rear direction. The rear portion of the first sorting unit 11 and the rear portion of the second sorting unit 12 are supported so as to be able to reciprocally move along the front-rear direction due to reciprocal swinging of the drive arm 52 around the arm axis P4. In this way, the first sorting unit 11 and the second sorting unit 12 are supported so as to be able to reciprocally move along the front-rear direction.

Configuration of Tension Wheel Body Provided for Transmission Chain

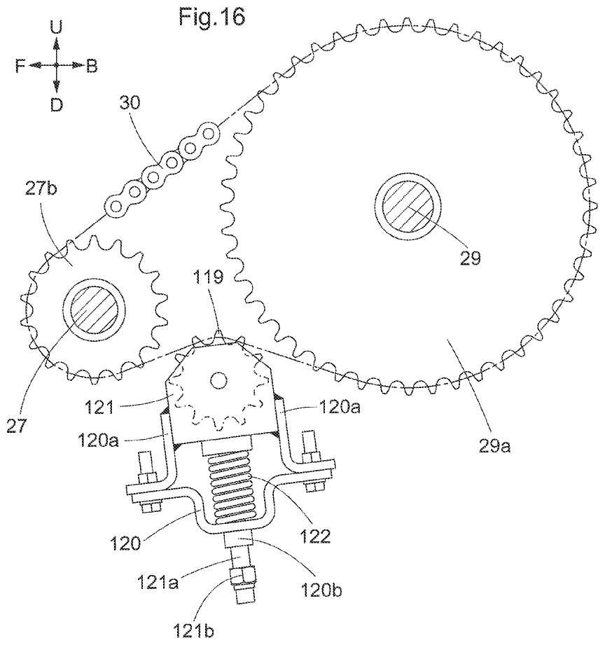

As shown in FIGS. 15 and 16, a tension wheel body 119 for maintaining the tension of the transmission chain 30 is provided below the transmission chain 30. A support member 120 bent into a channel shape is coupled to the left side wall 33, and a pair of angle-shaped guide portions 120a are coupled to the support member 120.

The tension wheel body 119 is supported by a channel-shaped wheel body support portion 121 so as to be rotatable around an axis along the left-right direction, and the wheel body support portion 121 can move vertically between the guide portions 120a of the support member 120. A guide rod 121a coupled to the wheel body support portion 121 is inserted into a boss portion 120b of the support member 120 and can slide up and down, and a retaining nut 121b is attached to a lower portion of the guide rod 121a of the wheel body support portion 121.

The guide rod 121a of the wheel body support portion 121 is inserted into a coil-shaped spring 122, and the spring 122 is provided between the wheel body support portion 121 and the support member 120 in a state of being compressed relative to the free length.

When the spring 122 attempts to extend from the compressed state relative to the free length, the tension wheel body 119 and the wheel body support portion 121 are pushed up by the biasing force of the spring 122, the tension wheel body 119 is pushed against the lower portion of the transmission chain 30, and thus the tension of the transmission chain 30 is maintained. In this case, the wheel body support portion 121 is guided by the guide portions 120a of the support member 120, and the wheel body support portion 121 moves up and down stably without tilting.

Configuration of Drive Member

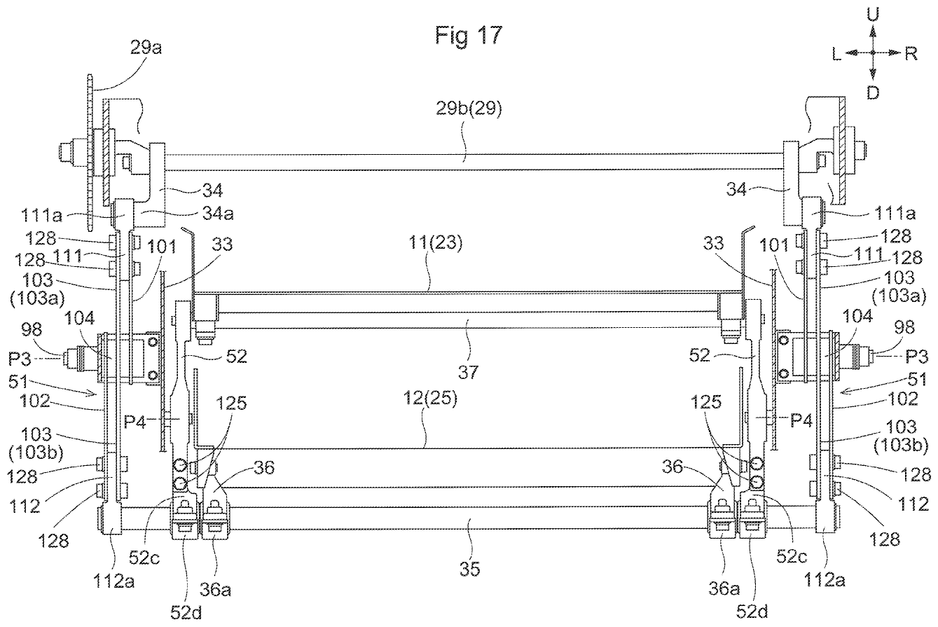

As shown in FIGS. 17, 18, and 19, the right and left drive members 51 each include a first member 101, a second member 102, a third member 103, boss portions 104, a first connecting portion 111, a second connecting portion 112, and the like. The right and left drive members 51 have a triangular shape in a side view, and are configured to be left-right symmetrical with each other.

The boss portions 104 are rotatably supported by the fulcrum shaft 98 and can rotate around the axis P3.

The first member 101 is plate-shaped with a width in the swing direction that is larger than the width in the direction orthogonal to the swing direction, and coupling holes 101a are formed in an end portion. The first member 101 is coupled to one of the boss portions 104 and is supported so as to be swingable around the axis P3.

The second member 102 is plate-shaped with a width in the swing direction that is larger than the width in the direction orthogonal to the swing direction, and coupling holes 102a are formed in an end portion. The second member 102 is coupled to the same boss portion 104 to which the first member 101 is coupled, and is supported so as to be swingable around the axis P3.

The third member 103 has a triangular shape in a side view and includes a portion 103a that extends along the first member 101, a portion 103b that extends along the second member 102, and a portion 103c that extends between a connection portion where the crank shaft 29 and the first member 101 are connected and a connection portion where the second sorting unit 12 (interconnecting shaft 35) and the second member 102 are connected, for example. Coupling holes 103d are formed in end portions of the portions 103a and 103c of the third member 103, and coupling holes 103e are formed in end portions of the portions 103b and 103c of the third member 103.

The portions 103a, 103b, and 103c of the third member 103 are plate-shaped with a width in the swing direction that is larger than the width in the direction orthogonal to the swing direction, and the portions 103a, 103b, and 103c of the third member 103 are integrally formed as a single member. The portions 103a and 103b of the third member 103 are coupled to the same boss portions 104 to which the first member 101 and the second member 102 are coupled, and are supported so as to be swingable around the axis P3.

The first member 101 and the second member 102 are coupled to the boss portions 104 with a gap between each other in a direction along the axis P3, and the first member 101 is arranged closer to the left-right center portion of the first and second sorting units 11 and 12 (closer to the side wall 33) than the second member 102 is. The third member 103 is arranged between the first member 101 and the second member 102 in a front view and in a rear view, and the portions 103a and 103b of the third member 103 are coupled to the boss portions 104.

The first connecting portion 111 is arranged between an end portion of the first member 101 and an end portion of the third member 103 (portions 103a and 103c) in a front view and in a rear view. Bolts 128 are tightly screwed into the coupling holes 101a of the first member 101, the coupling holes 103d of the third member 103, and the first connecting portion 111, and thus the first connecting portion 111 is coupled to the end portion of the first member 101 and the end portion of the third member 103 (portions 103a and 103c).

A connecting shaft 34a of the interconnecting link 34 is connected to a boss portion 111a of the first connecting portion 111, and the crank shaft 29 and the first connecting portion 111 are coupled via the interconnecting link 34.

The second connecting portion 112 is arranged between an end portion of the second member 102 and an end portion of the third member 103 (portions 103b and 103c) in a front view and in a rear view. Bolts 128 are tightly screwed to the coupling holes 102a of the second member 102, the coupling holes 103e of the third member 103, and the second connecting portion 112, and thus the second connecting portion 112 is coupled to the end portion of the second member 102 and the end portion of the third member 103 (portions 103b and 103c).

The interconnecting link 34 is connected to and extends between the crank portion 29b of the crank shaft 29 and the boss portion 111a of the first connecting portion 111, and thus the crank shaft 29 and the drive member 51 are connected to each other.

The interconnecting shaft 35 is connected to a boss portion 112a of the second connecting portion 112, and the second sorting unit 12 and the second connecting portion 112 are connected via the interconnecting shaft 35.

Configuration of Connection Portion Between Drive Arm and Interconnecting Shaft

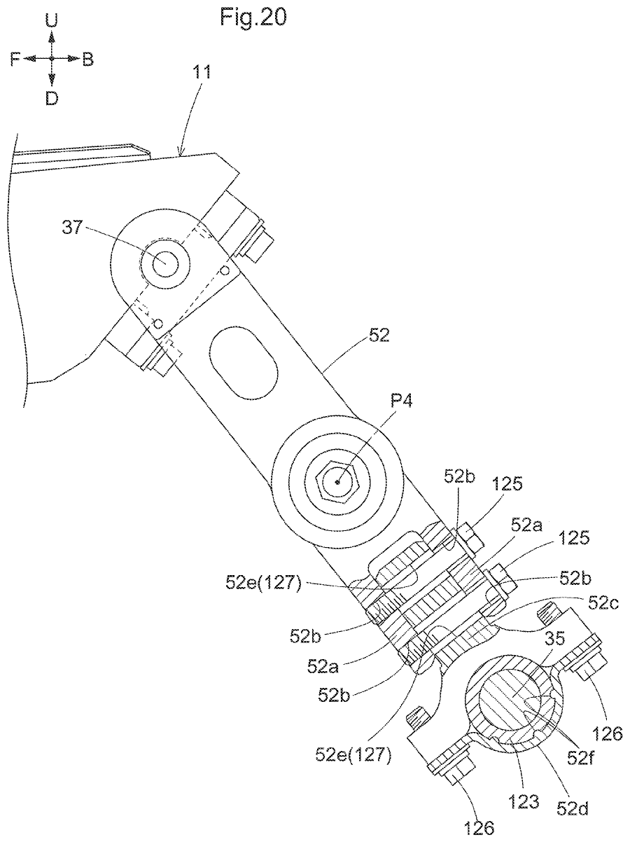

As shown in FIG. 20, a pair of square bar-shaped coupling portions 52a are provided in a lower portion of the drive arm 52, and a coupling hole 52b is formed in each of the coupling portions 52a. A connecting portion 52c and a connecting portion 52d are provided in a lower portion of the drive arm 52.

The connecting portion 52c of the drive arm 52 is formed as a rod-shaped portion that is integrally formed with a semicircular portion, and a coupling hole 52e having an elongated cross section is formed in the rod-shaped portion. The connecting portion 52d of the drive arm 52 has a semicircular shape.

The connecting portion 52c is inserted between the coupling portions 52a of the drive arm 52, bolts 125 are tightly screwed into the coupling holes 52b and 52e of the drive arm 52, and thus the connecting portion 52c is coupled to the coupling portion 52a of the drive arm 52.

An arm length adjusting portion 127 is constituted by the coupling hole 52e of the drive arm 52, and the length of the drive arm 52 from the arm axis P4 to the connection portion connected to the second sorting unit 12 (interconnecting shaft 35) can be adjusted within an extent defined by the coupling hole 52e of the drive arm 52.

A rubber cylindrical elastic body 123 is attached to the interconnecting shaft 35. The elastic body 123 is sandwiched between the connecting portions 52c and 52d of the drive arm 52, and bolts 126 are tightly screwed into the connecting portions 52c and 52d of the drive arm 52, and thus the drive arm 52 and the interconnecting shaft 35 are connected and sandwich the elastic body 123.

A plurality of protruding portions 52f are provided on the inner surface of the connecting portion 52d of the drive arm 52, and flange-shaped stopper portions (not shown) that face the interconnecting shaft 35 are provided at end portions of the connecting portion 52d of the drive arm 52 in the direction along the interconnecting shaft 35.

As described above, while the elastic body 123 is sandwiched between the connecting portions 52c and 52d of the drive arm 52, the protruding portions 52f of the connecting portion 52d of the drive arm 52 dig into the outer surface portion of the elastic body 123, and the stopper portions of the connecting portion 52d of the drive arm 52 abut against the end portion of the elastic body 123, thus preventing positional deviation of the elastic body 123.

Configuration of Connection Portion Between Connecting Member and Interconnecting Shaft

As shown in FIGS. 10 and 17, a semicircular connecting portion 36a is provided at a lower portion of the connecting member 36, and a rubber cylindrical elastic body 124 is attached to the interconnecting shaft 35. The elastic body 124 is sandwiched by the connecting portion 36a of the connecting member 36, bolts 126 are tightly screwed into the connecting portion 36a of the connecting member 36, and thus the connecting member 36 and the interconnecting shaft 35 are connected, with the elastic body 124 arranged therebetween.

The connecting portion 36a of the connecting member 36 is provided with protruding portions 36b and stopper portions (not shown) that are similar to the protruding portions 52f and the stopper portions of the connecting portion 52d of the drive arm 52.

Accordingly, the elastic body 123 is provided at the connection portion where the drive arm 52 and the second sorting unit 12 are connected, and the elastic bodies 123 and 124 are provided at the connection portion where the drive member 51 and the second sorting unit 12 are connected.

As shown in FIG. 15, instead of both of the elastic bodies 123 and 124 being provided, the elastic body 123 may be provided, and the elastic body 124 may be omitted. The elastic body 124 may be provided, and the elastic body 123 may be omitted. The elastic body 123 may be provided at the connection portion where the drive member 51 (second connecting portion 112) and the interconnecting shaft 37 are connected.

Configuration of Wear Prevention Member Provided Between Side Wall and Drive Arm/Drive Member

As shown in FIG. 15, at the right drive member 51 and the right side wall 33, and at the left drive member 51 and the left side wall 33, the drive member 51 (first member 101) and the side wall 33 are close to each other.

A wear prevention member 129 having excellent wear resistance is attached to a portion of the outer surface portion of the side wall 33 that faces the swing range of the drive member 51 (first member 101), and the wear prevention member 129 is arranged between the drive member 51 and the side wall 33 that covers the outward side of the first sorting unit 11 and the second sorting unit 12.

In this case, the wear prevention member 129 may be attached to the drive member 51 (first member 101) instead of being attached to the side wall 33, or may be attached to both the side wall 33 and the drive member 51 (first member 101).

At the right portion of the rear portion of the right drive arm 52 and the second sorting unit 12 (second sieve case 25), and at the left portion of the rear portion of the left drive arm 52 and the second sorting unit 12 (second sieve case 25), the drive arm 52 and the second sorting unit 12 (second sieve case 25) are close to each other.

A wear prevention member 130 having excellent wear resistance is attached to a portion of the outer surface portion of the rear portion of the second sorting unit 12 (second sieve case 25) that faces the swing range of the drive arm 52, and the wear prevention member 130 is arranged between the drive arm 52 and the second sorting unit 12.

In this case, the wear prevention member 130 may be attached to the drive arm 52 instead of being attached to the second sorting unit 12 (second sieve case 25), or may be attached to both the second sorting unit 12 (second sieve case 25) and the drive arm 52.

A configuration is possible in which the wear prevention member 130 is attached to a portion of the outer surface of the rear portion of the first sorting unit 11 (first sieve case 23) that faces the swing range of the drive arm 52, and the wear prevention member 130 is arranged between the drive arm 52 and the first sorting unit 11.

In this case, the wear prevention member 130 may be attached to the drive arm 52 instead of being attached to the first sorting unit 11 (first sieve case 23), or may be attached to both the first sorting unit 11 (first sieve case 23) and the drive arm 52.

Instead of providing both of the wear prevention members 129 and 130 as described above, the wear prevention member 129 may be provided, and the wear prevention member 130 may be omitted. The wear prevention member 130 may be provided, and the wear prevention member 129 may be omitted.

Reciprocating Driving of First Sorting Unit and Second Sorting Unit

Based on the above-described section “Configuration for reciprocating driving of first sorting unit and second sorting unit”, the first sorting unit 11 and the second sorting unit 12 are driven to reciprocate in opposite directions along the front-rear direction as described below.

As shown in FIGS. 15, 21, 22, motive power from the engine 8 is transmitted to the transmission shaft 17 via the transmission belt 18 (see the previous section “Configuration of threshing unit”), is transmitted to the transmission shaft 27 via the transmission belt 28, and is transmitted to the crank shaft 29 via the transmission chain 30.

When the crank shaft 29 is driven to rotate, the drive member 51 is driven to reciprocally swing around the axis P3 via the interconnecting link 34, and the second sorting unit 12 is driven by the drive member 51 to reciprocate along the front-rear direction via the interconnecting shaft 35 and the connecting member 36.

Due to the second sorting unit 12 reciprocating in the front-rear direction, the drive arm 52 is reciprocally swung around the arm axis P4 via the interconnecting shaft 35, and the first sorting unit 11 is driven to reciprocate in the front-rear direction.

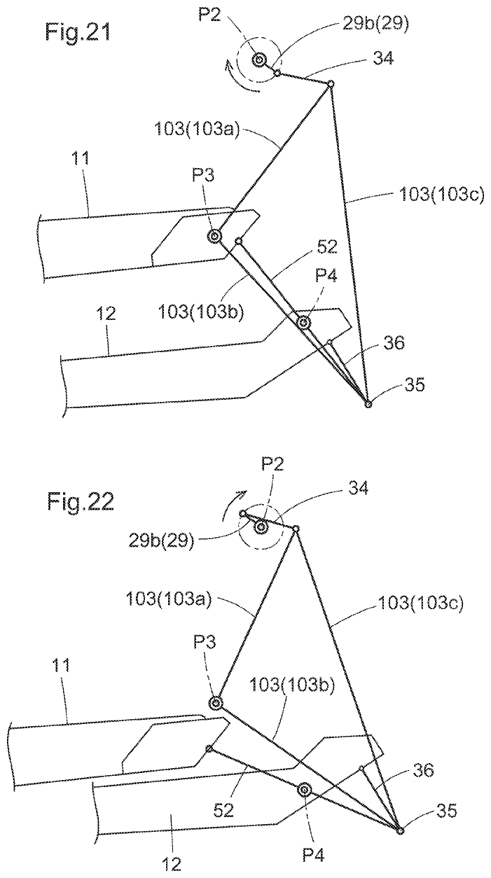

As shown in FIG. 21, when the second sorting unit 12 is driven forward, the drive arm 52 swings clockwise in FIG. 21, and the first sorting unit 11 is driven rearward. As shown in FIG. 22, when the second sorting unit 12 is driven rearward, the drive arm 52 swings counterclockwise in FIG. 22, and the first sorting unit 11 is driven forward. In this way, the first sorting unit 11 and the second sorting unit 12 are driven to reciprocate in opposite directions along the front-rear direction.

As shown in FIG. 4, the front-rear length of the second sorting unit 12 (second sieve case 25) is shorter than the front-rear length of the first sorting unit 11 (first sieve case 23). The plate thickness of the second sieve case 25 is set slightly thicker than the plate thickness of the first sieve case 23, and the weight of the first sorting unit 11 and the weight of the second sorting unit 12 are set substantially the same.

The above state is a state in which the first sorting unit 11 and the second sorting unit 12 are separately driven to reciprocate by the drive member 51, which is the first drive mechanism, and the drive arm 52, which is the second drive mechanism.

Out of the first sorting unit 11 and the second sorting unit 12, the second sorting unit 12 is reciprocally driven by the drive member 51, which is the first drive mechanism.

Out of the first sorting unit 11 and the second sorting unit 12, the reciprocating driving of the second sorting unit 12 is transmitted, via the drive arm 52 serving as the second drive mechanism, to the first sorting unit 11, which is the other one out of the first sorting unit 11 and the second sorting unit 12, and thus the first sorting unit 11, which is the other one out of the first sorting unit 11 and the second sorting unit 12, is driven to reciprocate.

Positional Relationship of Portions in First Sorting Unit and Second Sorting Unit

The following describes the positional relationship between portions when the first sorting unit 11 and the second sorting unit 12 are driven to reciprocate in the front-rear direction as described in the previous section “Reciprocating driving of first sorting unit and second sorting unit”.

In the states shown in FIGS. 4, 5, and 6, the first sorting unit 11 is located at the rear end in reciprocating movement, and the second sorting unit 12 is located at the front end in the reciprocating driving.

When the second sorting unit 12 is located at the front end in the reciprocating driving, the rear end portion 22a of the second grain pan 22 (the front end portion 26a of the grain sieve 26) is located rearward of a vertical line L1 that passes through the peak portion 54a of the front partition unit 54 in a side view.

When the second sorting unit 12 is located at the front end in the reciprocating driving, the rear end portion 21b of the first grain pan 21 and the front end portion 31a of the first chaff sieve 31 are located above a front-rear center portion 22b of the second grain pan 22.

Accordingly, in the state where the first sorting unit 11 is located at the rear end in the reciprocating movement and the second sorting unit 12 is located at the front end in the reciprocating driving, and also in the state where the first sorting unit 11 is located at the front end in the reciprocating movement and the second sorting unit 12 is located at the rear end in the reciprocating driving, the first grain pan 21, the first chaff sieve 31, and the second grain pan 22 are arranged such that the rear portion of the first grain pan 21 and the front portion of the first chaff sieve 31 are overlapped with the second grain pan 22 in a plan view.

The rear end portion 26b of the grain sieve 26 is located between a vertical line L2 that passes through the peak portion 55a of the rear partition unit 55 and a vertical line L3 that passes through the screw axis P6 of the secondary material collecting unit 42 in a side view.

In this case, when the second sorting unit 12 is located at the front end in the reciprocating driving, the rear end portion 26b of the grain sieve 26 is located slightly rearward of the vertical line L2 in a side view. When the second sorting unit 12 is located at the rear end in the reciprocating driving, the rear end portion 26b of the grain sieve 26 is located slightly forward of the vertical line L3 in a side view.

When the second sorting unit 12 is located at the front end in the reciprocating driving, the front end portion 32a of the second chaff sieve 32 is located at the position of a vertical line L4 that passes through the rear end portion of the conveying screw 53 of the secondary material collecting unit 42 in a side view, and the second chaff sieve 32 extends rearward from the vertical line L4 that passes through the rear end portion of the conveying screw 53 of the secondary material collecting unit 42 in a side view.

The straw rack 24 extends rearward until the rear end portion 24a of the straw rack 24 is located above the rear portion of the second chaff sieve 32.

A rearward and upward inclination angle B1 of the first chaff sieve 31 relative to the horizontal plane is set larger than a rearward and upward inclination angle B2 of the first grain pan 21 relative to the horizontal plane.

Until the front end portion 21a of the first grain pan 21 is located at the same position in the front-rear direction as the front end portion 65f of the grain fan case 65 (front case portion 65a), the first grain pan 21 extends forward through the space between the receiving net 14 and the grain fan case 65.

First Variation of First Invention

A configuration is possible in which a plurality of grain fans 47 are provided, sorting wind is supplied from one grain fan 47 to the first air passage A1, and sorting wind is supplied from another grain fan 47 to the second air passage A2.

Second Variation of First Invention

The first sorting unit 11 and the second sorting unit 12 may be configured to be driven to reciprocate in the same direction as each other along the front-rear direction.

First Variation of Second Invention A configuration is possible in which a plurality of grain fans 47 are provided, sorting wind is supplied from one grain fan 47 to the first air passage A1, and sorting wind is supplied from another grain fan 47 to the second air passage A2.

Second Variation of Second Invention

The first sorting unit 11 and the second sorting unit 12 may be configured to be driven to reciprocate in the same direction as each other along the front-rear direction.

First Variation of Third Invention

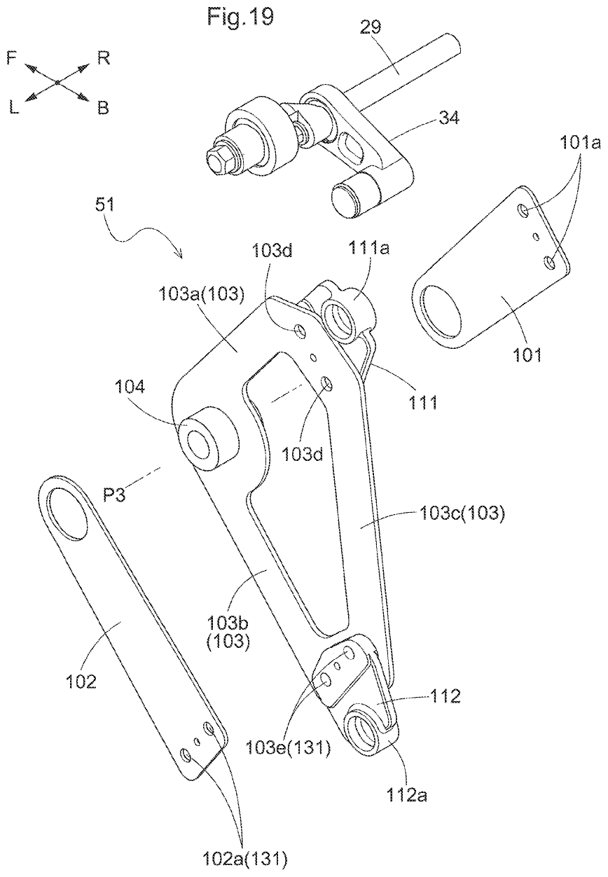

In the drive member 51 shown in FIG. 19, the coupling holes 102a and 103e of the drive member 51 (second member 102 and third member 103) may be elongated holes that extend along the radial direction from the axis P3.

According to this configuration, the coupling position of the second connecting portion 112 can be changed within the range allowed by the coupling holes 102a and 103e of the drive member 51 (second member 102 and third member 103).

A member length adjusting portion 131 is constituted by the coupling holes 102a and 103e of the drive member 51 (second member 102 and third member 103), and the length of the drive member 51 from the axis P3 to the connection portion for coupling to the second sorting unit 12 (interconnecting shaft 35) can be adjusted.

Out of the arm length adjusting portion 127 shown in FIGS. 15 and 20 and the member length adjusting portion 131 shown in FIG. 19, the arm length adjusting portion 127 may be provided and the member length adjusting portion 131 may be omitted. The member length adjusting portion 131 may be provided, and the arm length adjusting portion 127 may be omitted. Both the arm length adjusting portion 127 and the member length adjusting portion 131 may be provided.

Second Variation of Third Invention

The coupling between the drive member 51 and the interconnecting shaft 35 may be omitted, and the drive member 51 may be connected to the interconnecting shaft 37.

According to this configuration, the drive member 51 is connected to the first sorting unit 11 via the interconnecting shaft 37, and the drive member 51 is driven by the first sorting unit 11 to reciprocate along the front-rear direction. Due to the first sorting unit 11 reciprocating in the front-rear direction, the drive arm 52 is driven to reciprocally swing around the arm axis P4, and the second sorting unit 12 is driven to reciprocate along the front-rear direction.

When the first sorting unit 11 is driven forward, the drive arm 52 swings in the counterclockwise direction shown in FIG. 20, and the second sorting unit 12 is driven rearward. When the first sorting unit 11 is driven rearward, the drive arm 52 swings in the clockwise direction shown in FIG. 20, and the second sorting unit 12 is driven forward. In this way, the first sorting unit 11 and the second sorting unit 12 are driven to reciprocate in opposite directions along the front-rear direction.

The above state is a state in which the first sorting unit 11 and the second sorting unit 12 are driven to reciprocate separately by the drive member 51, which is the first drive mechanism, and the drive arm 52, which is the second drive mechanism.

The first sorting unit 11, which is one out of the first sorting unit 11 and the second sorting unit 12, is driven to reciprocate by the drive member 51, which is the first drive mechanism.

Out of the first sorting unit 11 and the second sorting unit 12, the reciprocating driving of the first sorting unit 11 is transmitted, via the drive arm 52 serving as the second drive mechanism, to the second sorting unit 12, which is the other one out of the first sorting unit 11 and the second sorting unit 12, and thus the second sorting unit 12, which is the other one out of the first sorting unit 11 and the second sorting unit 12, is driven to reciprocate.

Third Variation of Third Invention

The following configuration may be employed in the above-described “Second Variation of Third Invention”.

It is sufficient that the interconnecting shaft 37 is connected to the first sorting unit 11 via an elastic body 123 as shown in FIG. 15, and it is sufficient that the drive arm 52 is connected to the first sorting unit 11 (interconnecting shaft 37) via an elastic body 123 as shown in FIG. 15.

As a result, an elastic body 123 is provided at the connection portion between the drive member 51 and the first sorting unit 11, and an elastic body 123 is provided at the connection portion between the drive arm 52 and the first sorting unit 11. In this configuration, the elastic bodies 124 shown in FIG. 15 may be omitted.

An arm length adjusting portion 127 may be provided to adjust the length of the drive arm 52 from the arm axis P4 to the connection portion connected to the first sorting unit (interconnecting shaft 37). A member length adjusting portion 131 for adjusting the length of the drive member 51 from the axis P3 to the connection portion connected to the first sorting unit 11 (interconnecting shaft 37) may be provided.

Out of the arm length adjusting portion 127 and the member length adjusting portion 131, the arm length adjusting portion 127 may be provided and the member length adjusting portion 131 may be omitted. The member length adjusting portion 131 may be provided, and the arm length adjusting portion 127 may be omitted. Both the arm length adjusting portion 127 and the member length adjusting portion 131 may be provided.

Fourth Variation of Third Invention

In the case where the drive member 51 and the interconnecting shaft 35 are not coupled and the drive member 51 is connected to the interconnecting shaft 37, the connection between the drive arm 52 and the first sorting unit 11 may be omitted, and an interconnecting link (not shown) other than the interconnecting link 34 may be connected to and extend between the crank portion 29b of the crank shaft 29 and the drive arm 52.

According to this configuration, motive power transmitted to the crank shaft 29 is branched in parallel to two systems, motive power in one system is transmitted to the drive member 51, and the first sorting unit 11 is driven to reciprocate by the drive member 51. Motive power in the other system is transmitted to the drive arm 52, and the second sorting unit 12 is driven to reciprocate by the drive arm 52. The above state is a state in which the first sorting unit 11 and the second sorting unit 12 are driven to reciprocate separately by the drive member 51, which is the first drive mechanism, and the drive arm 52, which is the second drive mechanism.

Fifth Variation of Third Invention

A configuration is possible in which the drive member 51 and the interconnecting shaft 35 are coupled, the drive arm 52 and the interconnecting shaft 35 (second sorting unit 12) are not connected, and an interconnecting link (not shown) other than the interconnecting link 34 is connected to and extends between the crank portion 29b of the crank shaft 29 and the drive arm 52.

According to this configuration, motive power transmitted to the crank shaft 29 is branched in parallel to two systems, motive power in one system is transmitted to the drive member 51, and the second sorting unit 12 is driven to reciprocate by the drive member 51. Motive power in the other system is transmitted to the drive arm 52, and the first sorting unit 11 is driven to reciprocate by the drive arm 52. The above state is a state in which the first sorting unit 11 and the second sorting unit 12 are driven to reciprocate separately by the drive member 51, which is the first drive mechanism, and the drive arm 52, which is the second drive mechanism.

Sixth Variation of Third Invention

In the above-described “Fourth Variation of Third Invention” and “Fifth Variation of Third Invention”, the first sorting unit 11 and the second sorting unit 12 may be configured to be driven to reciprocate in the same direction as each other along the front-rear direction.

First Variation of Fourth Invention

Out of the right and left sixth wind direction members 76, the right sixth wind direction member 76 may be provided and the left sixth wind direction member 76 may be omitted. The left sixth wind direction member 76 may be provided, and the right sixth wind direction member 76 may be omitted.

A mesh-like sixth wind direction member 76 such as a crimp net may be provided instead of the flat plate-shaped sixth wind direction member 76 that has a large number of openings.

Second Variation of Fourth Invention

The sixth wind direction members 76 arranged between the first wind direction members 71 and the third wind direction members 73 may be configured as described below.

Instead of being coupled to the first wind direction members 71, the sixth wind direction members 76 may be coupled to the third wind direction members 73 and supported by the third wind direction members 73.

Instead of being coupled to the third wind direction members 73, the sixth wind direction members 76 may be coupled to the first wind direction members 71 and supported by the first wind direction members 71.

Instead of being coupled to the first wind direction members 71 and the third wind direction members 73, the sixth wind direction members 76 may be coupled to the side walls 33 and supported by the side walls 33.

Third Variation of Fourth Invention

In addition to being provided between the first wind direction members 71 and the third wind direction members 73, the sixth wind direction members 76 may be provided between the third wind direction members 73 and the bottom portion 54b of the front partition unit 54, and may be provided between the first wind direction members 71 and the second wind direction members 72.

Fourth Variation of Fourth Invention

Instead of both the first wind direction members 71 and the third wind direction members 73 being coupled to an inner surface portion that faces the reinforcing member 81 on the left side wall 33 to which the reinforcing member 81 is coupled, the first wind direction members 71 may extend between an inner surface portion that faces the reinforcing member 81 on the left side wall 33 to which the reinforcing member 81 is coupled and an inner surface portion of the right side wall 33 that faces the reinforcing member 81. The third wind direction members 73 may extend between an inner surface portion that faces the reinforcing member 81 on the left side wall 33 to which the reinforcing member 81 is coupled and an inner surface portion of the right side wall 33 that faces the reinforcing member 81.

Fifth Variation of Fourth Invention

The reinforcing member 81 and the rotation speed changing portion 83 may be coupled to an outer surface portion of the right side wall 33. According to this configuration, the first wind direction members 71 and the third wind direction members 73 may extend between an inner surface portion that faces the reinforcing member 81 on the right side wall 33 to which the reinforcing member 81 is coupled and an inner surface portion of the left side wall 33 that faces the reinforcing member 81. The first wind direction members 71 may extend between an inner surface portion that faces the reinforcing member 81 on the right side wall 33 to which the reinforcing member 81 is coupled and an inner surface portion of the left side wall 33 that faces the reinforcing member 81. The third wind direction members 73 may extend between an inner surface portion that faces the reinforcing member 81 on the right side wall 33 to which the reinforcing member 81 is coupled and an inner surface portion of the left side wall 33 that faces the reinforcing member 81.

Sixth Variation of Fourth Invention

One sorting unit may be provided instead of the two sorting units, namely the first sorting unit 11 and the second sorting unit 12.

First Variation of Fifth Invention

The coil spring 109 may be configured to bias the gap changing portion 106 in the closing direction.

According to this configuration, when the operation gear 114 is swung by the electric motor 115 and the inner portion 118a of the wire 118 is pulled toward the electric motor 115, the gap changing portion 106 is moved in the opening direction in resistance against the coil spring 109. When the operation gear 114 is swung by the electric motor 115 and the inner portion 118a of the wire 118 returns toward the gap changing portion 106, the coil spring 109 extends and the gap changing portion 106 moves in the closing direction.

Second Variation of Fifth Invention

Instead of both the coil spring 109 and the wire 118 (inner portion 118a) being connected to a common connecting portion 116b provided in the gap changing portion 106, the coil spring 109 may be connected to a portion other than the connecting portion 116b on the upper portion of the gap changing portion 106, and the wire 118 (inner portion 118a) may be connected to the connecting portion 116b of the gap changing portion 106.

The coil spring 109 and the wire 118 (inner portion 118a) may be connected to the same connecting portion 116b or another portion on the same lower portion of the gap changing portion 106 that extends from the swing axis P8.

Third Variation of Fifth Invention

Members such as the gap changing portion 106, the boss portion 107, the rod portion 108, the coil spring 109, the electric motor 115, the wire 118, and the like provided in the first chaff sieve 31 may be provided in the second chaff sieve 32. One sorting unit may be provided instead of the two sorting units, namely the first sorting unit 11 and the second sorting unit 12. Instead of the electric motor 115, an electric cylinder (not shown) or a hydraulic cylinder (not shown) may be used as an actuator.

Note that the configurations disclosed in the above embodiments (including the variations, and the same applies hereinafter) can be employed in combination with configurations disclosed in other embodiments as long as no contradiction arises. Moreover, the embodiments disclosed in the present specification are examples, and rather than being limited to these examples, the embodiments of the present invention can be appropriately modified without departing from the object of the present invention.

### INDUSTRIAL APPLICABILITY

The present invention is applicable not only to a threshing apparatus of a normal-type combine harvester but also to a threshing apparatus mounted in an autodetachable combine harvester.

### DESCRIPTION OF REFERENCE SIGNS

5 Threshing unit
11 First sorting unit (sorting unit)
12 Second sorting unit (sorting unit)
13 Threshing cylinder
13a Raking unit of threshing cylinder
13b Threshing processing unit of threshing cylinder
14 Receiving net
14a Front end portion of receiving net
21 First grain pan
21a Front end portion of first grain pan
21b Rear end portion of first grain pan
22 Second grain pan
22a Rear end portion of second grain pan
22b Front-rear center portion of second grain pan
23 First sieve case
24 Straw rack
24a Rear end portion of straw rack
25 Second sieve case
26 Grain sieve
26b Rear end portion of grain sieve
31 First chaff sieve (chaff sieve)
32 Second chaff sieve
33 Side wall
41 Primary material collecting unit
42 Secondary material collecting unit
47 Grain fan
48 Wall portion
48a Upper portion of wall portion
51 Drive member (first drive mechanism)
52 Drive arm (second drive mechanism)
53 Transport screw
54 Front partition unit
54a Peak portion of front partition unit
54b Bottom portion of front partition unit
55 Rear partition unit
55a Peak portion of rear partition unit
60 Gap
65 Grain fan case
65d Lower end portion of grain fan case
65f Front end portion of grain fan case
71 First wind direction member (upper wind direction member)
72 Second wind direction member
73 Third wind direction member (lower wind direction member)
73a Rear end portion of third wind direction member
74 Fourth wind direction member
74a Rear end portion of fourth wind direction member
76 Sixth wind direction member (wind direction member)
81 Reinforcing member
83 Rotation speed changing portion
99 Chaff lip
106 Gap changing portion
106b Connecting portion of gap changing portion
107 Boss portion
108 Rod portion
108a Spring receiving portion of rod portion
109 Coil spring
115 Electric motor (actuator)
118 Wire
123 Elastic body
124 Elastic body
127 Arm length adjusting portion
129 Wear prevention member
130 Wear prevention member
131 Member length adjusting portion
A1 First air passage
A2 Second air passage
B1 Inclination angle
B2 Inclination angle
L1 Vertical line
L2 Vertical line
L3 Vertical line
L4 Vertical line
P1 Rotation axis
P3 Axis
P4 Arm axis
P6 Screw axis
P8 Swing axis
W1 Gap

1. A threshing apparatus comprising:
a threshing unit configured to thresh a harvested crop;
a first sorting unit that is arranged below the threshing unit, is reciprocally drivable along a front-rear direction, and is configured to perform sorting on a processed material from the threshing unit; and
a second sorting unit that is arranged below the first sorting unit, is reciprocally drivable along the front-rear direction, and is configured to perform sorting on a processed material from the first sorting unit,
wherein the second sorting unit comprises a front end portion that is provided with a second grain pan configured to convey processed material rearward, and
wherein the second grain pan comprises a front end portion that is provided with a wall portion that is higher than the second grain pan so as to prevent processed material from falling forward from the second grain pan.

2. The threshing apparatus according to claim 1, wherein:
an upper portion of the wall portion is inclined upward and rearward,
the threshing apparatus further comprises a grain fan configured to supply sorting wind to the first sorting unit and the second sorting unit, and
a portion of the sorting wind from the grain fan flows rearward between the first sorting unit and the wall portion.

3. The threshing apparatus according to claim 1, further comprising:
a primary material collecting unit provided below the second sorting unit;
a secondary material collecting unit provided at a position that is below the second sorting unit and rearward of the primary material collecting unit;
a grain fan that is configured to supply sorting wind to the first sorting unit and the second sorting unit, and is located forward of the primary material collecting unit;
a first grain pan configured to convey processed material rearward, a first chaff sieve configured to perform sorting while conveying processed material rearward and allow processed material to fall downward, and a straw rack configured to perform sorting while conveying processed material rearward and allow processed material to fall downward, the first grain pan, the first chaff sieve, and the straw rack extending in stated order between a front portion and a rear portion of the first sorting unit; and
a second grain pan, a grain sieve configured to allow sorted processed material to fall to the primary material collecting unit, and a second chaff sieve configured to perform sorting while conveying the processed material rearward and allow processed material to fall to the secondary material collecting unit, the second grain pan, the grain sieve, and the second chaff sieve extending in stated order between a front portion and a rear portion of the second sorting unit.

4. The threshing apparatus according to claim 3, further comprising:
a front partition unit that is mountain-shaped and projects upward in a side view, and is located between the primary material collecting unit and the grain fan,
wherein the grain sieve extends rearward from a rear end portion of the second grain pan, and
wherein when the second sorting unit is located at a front end in reciprocating driving, the rear end portion of the second grain pan is located rearward of a vertical line that passes through a peak portion of the front partition unit in a side view.

5. The threshing apparatus according to claim 3,
wherein the first chaff sieve extends rearward from a rear end portion of the first grain pan, and
wherein the first grain pan, the first chaff sieve, and the second grain pan are arranged such that a rear portion of the first grain pan and a front portion of the first chaff sieve are overlapped with the second grain pan in a plan view.

6. The threshing apparatus according to claim 5,
wherein the rear end portion of the first grain pan is located above a front-rear center portion of the second grain pan.

7. The threshing apparatus according to claim 3, further comprising:
a conveying screw that is provided in the secondary material collecting unit and configured to convey processed material by being driven to rotate about a screw axis that extends along a left-right direction; and
a rear partition unit that is mountain-shaped and projects upward in a side view, and is located between the primary material collecting unit and the secondary material collecting unit,
wherein a rear end portion of the grain sieve is located between a vertical line that passes through a peak portion of the rear partition unit and a vertical line that passes through the screw axis in a side view.

8. The threshing apparatus according to claim 7,
wherein the second chaff sieve extends rearward from a vertical line that passes through a rear end portion of the conveying screw in a side view.

9. The threshing apparatus according to claim 3,
wherein the straw rack extends rearward such that a rear end portion of the straw rack is located above a rear portion of the second chaff sieve.

10. The threshing apparatus according to claim 3,
wherein the first grain pan and the first chaff sieve are inclined rearward and upward, and
a rearward and upward inclination angle of the first chaff sieve is greater than a rearward and upward inclination angle of the first grain pan.

11. The threshing apparatus according to claim 3,
wherein the threshing unit comprises:
a threshing cylinder that is configured to be driven to rotate about a rotation axis extending in a front-rear direction and comprises a raking unit configured to rake a harvested crop rearward and a threshing processing unit that is continuous with a rear portion of the raking unit and is configured to thresh the crop, and
a receiving net arranged below the threshing processing unit, and
wherein:
the raking unit is provided at a front portion of the threshing cylinder so as to project forward of a front end portion of a grain fan case covering an outward side of the grain fan,
a front end portion of the receiving net and the front end portion of the grain fan case are located at the same position in a front-rear direction, and
the first grain pan extends forward between the receiving net and the grain fan case such that a front end portion of the first grain pan is located at the same position as the front end portion of the grain fan case in the front-rear direction.

12. A threshing apparatus comprising:
a threshing unit configured to thresh a harvested crop;
a first sorting unit that is arranged below the threshing unit, comprises a first sieve case, and is configured to perform sorting processing on a processed material from the threshing unit;
a second sorting unit that is arranged below the first sorting unit, comprises a second sieve case, and is configured to perform sorting processing on a processed material from the first sorting unit;
a grain fan that is arranged below a front end of the threshing unit and is configured to supply sorting wind; and
a first air passage configured to guide sorting wind from the grain fan to a space between the first sorting unit and the second sorting unit.

13. The threshing apparatus according to claim 12,
wherein a front portion of the first sorting unit extends forward such that the front portion of the first sorting unit is located forward of a front portion of the second sorting unit, and
wherein the grain fan is arranged at a location that is below the front portion of the first sorting unit and forward of the front portion of the second sorting unit.

14. The threshing apparatus according to claim 12,
wherein the first sorting unit comprises:
a first grain pan that is provided in a front portion of the first sorting unit and is configured to convey processed material rearward, and
a first chaff sieve that is provided in the first sorting unit so as to extend rearward from a position separated from a rear end portion of the first grain pan by a gap and is configured to perform sorting while conveying processed material rearward and allow processed material to fall downward, and
wherein the threshing apparatus further comprises a second wind direction member configured to guide sorting wind in the first air passage to the gap.

15. The threshing apparatus according to claim 14, wherein:
a front portion of the first sorting unit extends forward such that the front portion of the first sorting unit is located forward of a front portion of the second sorting unit,
the second wind direction member is arranged at a location that is below a front portion of the first sorting unit and forward of a front portion of the second sorting unit, and is inclined rearward and upward, and
sorting wind in the first air passage that passes above the second wind direction member is guided to the gap, and sorting wind in the first air passage that passes below the second wind direction member is guided to a space between the first sorting unit and the second sorting unit.

16. The threshing apparatus according to claim 15,
wherein sorting wind in the first air passage that passes above the second wind direction member flows along a bottom portion of the first grain pan and is guided to the gap.

17. The threshing apparatus according to claim 15,
wherein sorting wind in the first air passage that passes below the second wind direction member is guided from a space between the second wind direction member and a wall portion provided at a front end portion of the second sorting unit to a space between the first sorting unit and the second sorting unit.

18. The threshing apparatus according to claim 12, further comprising:
a second air passage configured to guide sorting wind supplied by the grain fan from a space below the second sorting unit to the second sorting unit.

19. The threshing apparatus according to claim 18, further comprising:
a first wind direction member configured to branch sorting wind from the grain fan and guide one portion of the sorting wind to the first air passage and another portion of the sorting wind to the second air passage.

20. The threshing apparatus according to claim 18, further comprising:
a primary material collecting unit provided below the second sorting unit,
wherein the second sorting unit comprises:
a second grain pan that is provided in a front portion of the second sorting unit and is configured to convey processed material rearward, and
a grain sieve that is provided in the second sorting unit so as to extend rearward from a rear end portion of the second grain pan and is configured to allow sorted processed material to fall to the primary material collecting unit, and
wherein sorting wind in the second air passage flows along a bottom portion of the second grain pan and is guided to a bottom portion of the grain sieve.

21. The threshing apparatus according to claim 18, further comprising:
a bottom portion that extends rearward from a lower end portion of a grain fan case that covers an outward side of the grain fan;
a primary material collecting unit provided at a location that is below the second sorting unit and rearward of a rear end portion of the bottom portion; and
a third wind direction member configured to branch sorting wind in the second air passage and guide a portion of the sorting wind along the bottom portion.

22. The threshing apparatus according to claim 21, further comprising:
a fourth wind direction member that is configured to guide sorting wind in the second air passage so as to flow along the bottom portion, and is separated rearward from a rear end portion of the third wind direction member by a gap,
wherein the rear end portion of the third wind direction member extends downward, and a rear end portion of the fourth wind direction member extends downward, and
wherein sorting wind flowing along the bottom portion flows in a space between the third wind direction member and the bottom portion and in a space between the fourth wind direction member and the bottom portion, and is guided to an upper portion of the primary material collecting unit.

23. A threshing apparatus comprising:
a threshing unit configured to thresh a harvested crop;
a first sorting unit that is disposed below the threshing unit, is supported so as to be reciprocally drivable along a front-rear direction, and is configured to perform sorting on a processed material from the threshing unit;
a second sorting unit that is disposed below the first sorting unit, is supported so as to be reciprocally drivable along the front-rear direction, and is configured to perform sorting on a processed material from the first sorting unit; and
a first drive mechanism and a second drive mechanism that are configured to separately drive the first sorting unit and the second sorting unit to reciprocate.

24. The threshing apparatus according to claim 23,
wherein the first sorting unit and the second sorting unit are driven to reciprocate in mutually opposite directions.

25. The threshing apparatus according to claim 23,
wherein one sorting unit out of the first sorting unit and the second sorting unit is driven to reciprocate by the first drive mechanism, and
wherein reciprocating driving of the one sorting unit is transmitted via the second drive mechanism to another sorting unit out of the first sorting unit and the second sorting unit such that the other sorting unit is driven to reciprocate.

26. The threshing apparatus according to claim 25, wherein:
the second drive mechanism is a drive arm that extends to one side and to an other side from an arm axis extending along a left-right direction, and is supported so as to be reciprocally swingable around the arm axis,
one portion of the drive arm on one side of the arm axis is connected to the first sorting unit, and another portion of the drive arm on an other side of the arm axis is connected to the second sorting unit,
due to one sorting unit out of the first sorting unit and the second sorting unit being driven to reciprocate by the first drive mechanism, the drive arm is driven to swing reciprocally, and an other sorting unit out of the first sorting unit and the second sorting unit is driven to reciprocate, and
the first sorting unit and the second sorting unit are driven to reciprocate in mutually opposite directions.

27. The threshing apparatus according to claim 26,
wherein the first drive mechanism is a drive member that is supported so as to be reciprocally swingable around an axis extending along the left-right direction, and is connected to one sorting unit out of the first sorting unit and the second sorting unit, and
wherein the threshing apparatus further comprises an elastic body provided on at least one out of:
a connection portion between the drive member and either the first sorting unit or the second sorting unit, and
a connection portion between the drive arm and either the first sorting unit or the second sorting unit.

28. The threshing apparatus according to claim 27, further comprising:
at least one out of:
a member length adjusting portion configured to adjust the length of the drive member from the axis to a connection portion connected to either the first sorting unit or the second sorting unit, and
an arm length adjusting portion configured to adjust the length of the drive arm from the arm axis to a connection portion connected to either the first sorting unit or the second sorting unit.

29. The threshing apparatus according to claim 27, further comprising:
a wear prevention member arranged in at least one out of:
a space between the drive member and a side wall that covers an outward side of the first sorting unit and the second sorting unit, and
a space between the drive arm and either the first sorting unit or the second sorting unit.

30. A threshing apparatus comprising:
a threshing unit configured to thresh a harvested crop, a sorting unit that is arranged below the threshing unit and is configured to perform sorting on a processed material from the threshing unit, and a grain fan that is arranged forward of the sorting unit and is configured to supply sorting wind to the sorting unit, the threshing unit, the sorting unit, and the grain fan arranged between left and right side walls; and
wind direction members configured to guide sorting wind, which is from the grain fan and flows along the side walls, toward a lateral center region between the left and right side walls.

31. The threshing apparatus according to claim 30,
wherein the wind direction members are each shaped as a flat plate having many openings, and are each arranged in an inclined orientation in which a rear portion of the wind direction member is closer to the lateral center region than a front portion of the wind direction member.

32. The threshing apparatus according to claim 30, wherein:
one of the wind direction members is a right wind direction member configured to guide sorting wind, which is from the grain fan and flows along the right side wall, toward the lateral center region between the left and right side walls, and
another one of the wind direction members is a left wind direction member configured to guide sorting wind, which is from the grain fan and flows along the left side wall, toward the lateral center region between the left and right side walls.

33. The threshing apparatus according to claim 30, further comprising:
an upper wind direction member that extends between the left and right side walls and is configured to guide sorting wind from the grain fan to the sorting unit; and
a lower wind direction member that extends between the left and right side walls, is arranged below the upper wind direction member, and is configured to guide sorting wind from the grain fan to the sorting unit,
wherein the wind direction members are arranged between the upper wind direction member and the lower wind direction member.

34. The threshing apparatus according to claim 33,
wherein the wind direction members are coupled to the upper wind direction member and the lower wind direction member.

35. The threshing apparatus according to claim 33, further comprising:
a reinforcing member coupled to an outer surface portion of one side wall out of the left and right side walls; and
a rotation speed changing portion that is configured to change an air volume of sorting wind from the grain fan by changing a rotation speed of the grain fan, and is supported by the reinforcing member,
wherein at least one wind direction member out of the upper wind direction member and the lower wind direction member extends between an inner surface portion that faces the reinforcing member on the one side wall to which the reinforcing member is coupled and an inner surface portion that faces the reinforcing member on an other one of the left and right side walls.

36. A threshing apparatus comprising:
a threshing unit configured to thresh a harvested crop;
a sorting unit that comprises a chaff sieve in which many chaff lips extending along a left-right direction are arranged side by side along a front-rear direction, is arranged below the threshing unit, and is configured to perform sorting on a processed material from the threshing unit;
a gap changing portion configured to operate the chaff lips toward an open state such that the size of a gap between adjacent chaff lips increases, and toward a closed state such that the size of the gap decreases;
a coil spring configured to bias the gap changing portion toward one state out of the open state and the closed state by extending from a compressed state relative to a free length of the coil spring; and
an actuator and a wire that is connected to and extends between the actuator and the gap changing portion,
wherein due to the wire being pulled toward the actuator by the actuator, the gap changing portion is operated toward an other state out of the open state and the closed state in resistance against the coil spring.

37. The threshing apparatus according to claim 36,
wherein the gap changing portion is biased toward the open state by the coil spring, and
wherein due to the wire being pulled toward the actuator by the actuator, the gap changing portion is operated toward the closed state in resistance against the coil spring.

38. The threshing apparatus according to claim 36,
wherein the gap changing portion is supported so as to be swingable around a swing axis, and
wherein the coil spring and the wire are both connected to one portion of the gap changing portion that extends from the swing axis, and are arranged side by side so as to extend along each other.

39. The threshing apparatus according to claim 38,
wherein the coil spring and the wire are both connected to a common connecting portion provided in the gap changing portion.

40. The threshing apparatus according to claim 36, further comprising:
a boss portion connected to the gap changing portion, and a rod portion that is connected to the sorting unit and is slidably inserted into the boss portion,
wherein the rod portion is inserted into the coil spring, and the coil spring is provided between the boss portion and a spring receiving portion provided on the rod portion, and
wherein the gap changing portion is biased via the boss portion due to the coil spring attempting to extend from the compressed state relative to the free length.
